(19) United States
(12) Patent Application Publication
(10) Pub. No.: US 2025/0296843 A1
(43) Pub. Date: Sep. 25, 2025

(54) METHODS FOR LOW ENERGY INORGANIC MATERIAL SYNTHESIS

(71) Applicant: Rutgers, The State University of New Jersey, New Brunswick, NJ (US)

(72) Inventors: Richard E. Riman, Piscataway, NJ (US); Daniel Kopp, Fair Lawn, NJ (US)

(73) Assignee: Rutgers, The State University of New Jersey, New Brunswick, NJ (US)

(21) Appl. No.: 18/860,183

(22) PCT Filed: Apr. 25, 2023
(86) PCT No.: PCT/US2023/066175

§ 371 Date: Oct. 25, 2024

Related U.S. Application Data
(60) Provisional application No. 63/363,602, filed on Apr. 26, 2022.

(51) Int. Cl. C01B 33/24; C01B 33/22

(52) U.S. Cl. CPC C01B 33/24; C01B 33/22

(57) ABSTRACT

The present invention relates to methods for low energy solvothermal vapor synthesis in an unsaturated vapor-phase reaction medium. By regulating the amount and pressure of carbon dioxide in the reaction medium, the product composition can be controlled.

### CROSS-REFERENCE TO RELATED APPLICATIONS

This application claims priority under 35 U.S.C. § 119(e) to U.S. Provisional Patent Application No. 63/363,602, filed Apr. 26, 2022. The foregoing application is incorporated by reference herein in its entirety.

### FIELD OF THE INVENTION

The present invention is directed to a method for facilitating the crystallization of a phase from a mixture of selected inorganic or organic precursors in a vapor-phase reaction medium. By adjusting the temperature and the partial pressures of the reaction medium and regulating the partial pressures of carbon dioxide, product phases can be selectively partitioned out.

### BACKGROUND

There are many inefficiencies and negative consequences of traditional material synthesis techniques (e.g., solid-state, sol-gel, mechano-chemical, hydrothermal). Hydrothermal chemistries have been studied and manipulated over several decades to enable crystal growth technologies and kinetically drive chemical reactions. Current hydrothermal synthesis techniques, such as liquid-phase hydrothermal synthesis (LPH), vapor-phase hydrothermal synthesis (VPH), supercritical water synthesis (SCW), and vapor-assisted solid-state synthesis (VS), suffer from a variety of disadvantages.

In traditional hydrothermal systems such as “liquid-phase hydrothermal” synthesis (LPH), the liquid water is used as the solvent and reaction medium and any reactants are always dispersed or submerged in it. Additives such as mineralizers are typically added to the water to enhance its solvation properties. The pressure within the hydrothermal autoclave is governed by the water liquid-vapor equilibrium phase boundary. This means that the liquid and gaseous water always coexist. However, certain products, such as MgAl₂O₄ (spinel) or CaSiO₃ (calcium silicate) cannot be synthesized using LPH reactions.

Similarly to “liquid-phase hydrothermal”, “vapor-phase hydrothermal” synthesis (VPH) is also conducted below 374° C. and 3200 psi (22 MPa). Once again, this means that both liquid and gaseous water are in equilibrium throughout reaction progression. The difference, however, is in the precursor configuration. The precursors are suspended above the liquid phase and solely interact with water vapor or liquid water that condenses on a reactor surface and falls onto the powder mixture. This configuration allows precursor interactions with a gaseous atmosphere but is limited in versatility since an arbitrary pressure cannot be maintained constant over a range of temperatures. Instead, the pressure is fixed by Gibb's phase rule. In the case of a “bleed-out” valve being implemented, the pressure can remain constant, but liquid-vapor equilibrium will no longer be maintained, which could create a need for water replenishment and/or large variations in pressure.

Supercritical water synthesis (SCW), which reacts precursors at supercritical temperature and pressure, typically requires thick-walled corrosion-resistant autoclaves. The cost of this vessel increases dramatically when approaching or exceeding the supercritical limit of water due to the corrosive properties of supercritical water.

Other methods such as vapor-assisted solid-state reactions are kinetically controlled, rather than thermodynamically controlled. Further, these vapor-assisted reactions are operating under equilibrium controlled reaction conditions (pressure is fixed at 1 atm) and therefore are limited in versatility due to the Gibb's phase rule.

Thus, a need exists for a versatile, thermodynamically controlled, low temperature method to crystallize inorganic oxides from readily available materials. Such a method will also minimize undesirable environmental impact.

### SUMMARY OF THE DISCLOSURE

The patent document relates to methods of facilitating the selective crystallization of a product phase in a vapor-phase reaction medium. Methods disclosed herein also demonstrate the understanding of pressure control within a reactor and the reaction thermodynamics between selected precursors and allows for reaction manipulation at temperature and pressure much lower than what has been known in the field.

One aspect of the invention provides a method of synthesizing an inorganic product such as a metal silicate or a metal silicate hydrate. The method includes:
providing a silicon precursor and a metal oxide precursor in a reactor;
providing in the reactor a reaction medium comprising a vapor phase of unsaturated water, wherein the vapor phase is an equilibrium unsaturated water vapor, wherein the unsaturated water vapor has a partial pressure of greater than 1 atm;
providing carbon dioxide (CO₂) is in gaseous form; and
reacting the silicon precursor and the metal oxide precursor in the reaction medium at
a predetermined temperature to form the metal silicate or the metal silicate hydrate;
   wherein the temperature, the pressure of the unsaturated vapor pressure, and the pressure of CO₂ are selected to reduce the non-standard state change in Gibb's free energy of the reaction for the formation of the metal silicate or the metal silicate hydrate to less than or equal to zero kJ/mol.

In some embodiments, the temperature, the pressure of the unsaturated vapor pressure, and the pressure of CO₂ are selected so that the synthesis is selective for the metal silicate over the metal silicate hydrate. In some embodiments, the temperature, the pressure of the unsaturated vapor pressure, and the pressure of CO₂ are selected so that the synthesis is selective for the metal silicate hydrate over the metal silicate.

In some embodiments, the metal oxide precursor includes a member selected from CaO, Ca(OH)₂, CaCO₃, and any combination thereof. In some embodiments, the silicon precursor comprises SiO₂.

In some embodiments, the reactor is a closed system. In some embodiments, the reactor is an open system and allows for continuous or semi-continuous precursors feeding and/or product removal.

In some embodiments, the at least one reaction product has the chemical formula of Aₐ B_{b} C_{c} Z_{z} Y_{y} Xₓ(α)_{f}(β₃)_{f}(γ)ₕ·i(δ)·j(ε)·k(θ), wherein
A, B, and C are each a single or multi-elemental cation species;
Z, Y, and X are each a single or multi-elemental anion species;
A, β, and γ are each a charged molecule;
Δ, ε, θ are each a neutral molecule; and
a, b, c, d, e, f, g, h, i, j, and k are values equal to or greater than 0.

Another aspect provides a compound prepared according to methods of the present invention.

A further aspect provides method of changing the amount of a metal silicate hydrate or a metal carbonate hydrate in a composition. The method includes:
providing in a reactor a reaction medium comprising a vapor phase of unsaturated water, wherein the vapor phase is an equilibrium unsaturated water vapor, wherein the unsaturated water vapor has a partial pressure of greater than 1 atm;
contacting the composition with gaseous carbon dioxide (CO₂) at a predetermined temperature;
   wherein the temperature, the pressure of the unsaturated vapor pressure, and the pressure of CO₂ are selected to change the amount of the metal silicate hydrate or the metal carbonate hydrate.

### BRIEF DESCRIPTION OF THE DRAWINGS

FIG. 1 illustrates a chemical equilibrium diagram for the MgCO₃:SiO₂:H₂O:CO₂ reaction system at 10 atm P_{H2O}. Specific products being included are MgCO₃, MgO, and Mg(OH)₂. Subscripts 1 and 2 correspond to the stable and meta-stable phase, respectively. (A) 4MgCO₃+2SiO₂ (B) Mg₃Si₂O(OH)₄+MgCO₃ (C) Mg₃Si₂O₅(OH)₄+Mg(OH)₂ (D₁) Mg₃Si₂O₅(OH)₄+Mg(OH)₂ (D₂) Mg₂SiO₄ (E₁) Mg₃Si₂O₅(OH)₄+MgCO₃ (E₂) Mg₂SiO₄(F₁) Mg₃Si₂O₅(OH)₄+MgO (F₂) Mg₂SiO₄ (G₁) Mg₂SiO₄ (G₂) Mg₃Si₂O₃ (OH)₄+MgO (H₁) Mg₂SiO₄(H₂) Mg₃Si₂O₅(OH)₄+MgCO₃ (I) Mg₂SiO₄

FIG. 2 illustrates a chemical equilibrium diagram for the MgCO₃:SiO₂:H₂O:CO₂ reaction system at 100 atm P_{H2O}. Specific products being included are MgCO₃, MgO, and Mg(OH)₂. Subscripts 1 and 2 correspond to the stable and meta-stable phase, respectively. (A) 4MgCO₃+2SiO₂ (B) Mg₃Si₂O₅(OH)₄+MgCO₃ (C) Mg₃Si₂O₅(OH)₄+Mg(OH)₂ (D₁) Mg₃Si₂O₅(OH)₄+Mg(OH)₂ (D₂) Mg₂SiO₄(E₁) Mg₃Si₂O(OH)₄+MgCO₃(E₂) Mg₂SiO₄ (F₁) Mg₃Si₂O₅(OH)₄+MgO (F₂) Mg₂SiO₄ (G) Mg₃Si₂O₅ (OH)₄+MgO (H) Mg₂SiO₄ (H₂) Mg₃Si₂O₅(OH)₄+MgCO₃ (I) Mg₂SiO₄

FIG. 3 illustrates a chemical equilibrium diagram for the MgCO₃:SiO₂:H₂O:CO₂ reaction system at 10 atm P_{H2O}. Specific products being included are MgCO₃, MgO, and Mg(OH)₂. Subscripts 1 and 2 correspond to the stable and meta-stable phase, respectively. (A) 3MgCO₃+2SiO₂ (B) Mg₃SiO₅(OH)₄ (C) Mg₃Si₂O₅(OH)₄ (D₁) Mg₃Si₂O₅(OH)₄ (D₂) Mg₂SiO₄+Mg(OH)₂+SiO₂ (E₃) Mg₃Si₂O₅(OH)₄ (E₂) Mg₂SiO₄+MgCO₃+SiO₂(F₁) Mg₃Si₂O₅(OH)₄ (F₂) Mg₂SiO₄+MgO+Si₂ (G) Mg₂SiO₄+MgO+SiO₂(G₂) Mg₃Si₂O₅(OH)₄ (H₁) Mg₂SiO₄+MgCO₃+SiO₂ (H₂) Mg₃Si₂O₅(OH)₄ (I) Mg₂SiO₄+MgCO₃+SiO₂

FIG. 4 illustrates a chemical equilibrium diagram for the MgCO₃:SiO₂:H₂O:CO₂ reaction system at 100 atm P_{H2O}. Diagram expands on the phase fields-presented in FIG. 6 by incorporating bi-products that could form as a result of a phase transformation from Mg₂SiO₄ to Mg₃Si₂O₅(OH)₄ or vice-versa. Specific products being included are MgCO₃, MgO, and Mg(OH)₂. Subscripts 1 and 2 correspond to the stable and meta-stable phase, respectively. (A) 3MgCO₃+2SiO₂ (B) Mg₃Si₄O₅(OH)₄ (C) Mg₃Si₂O₅(OH)₄ (D₁) Mg₃Si₂O₅(OH)₄ (D₂) Mg₂SiO₄+Mg(OH), +SiO₂ (E₁) Mg₃Si₂O₅(OH)₄ (E₂) Mg₂SiO₄+MgCO₃+SiO₂ (F₁) Mg₃Si₂O₅(OH)₄ (F₂) Mg₂SiO₄+MgO+SiO₂ (G) Mg₃Si₂O₅(OH)₄ (H₁) Mg₂SiO₄+MgCO₃+SiO₂ (H₂) Mg₃Si₂O₅(OH)₄ (I) Mg₂SiO₄+MgCO₃+SiO₂

FIG. 5 illustrates a temperature-gradient-based continuous reactor.

### DETAILED DESCRIPTION OF PREFERRED EMBODIMENTS

The present invention provides versatile methods of synthesizing inorganic products at relatively low temperatures and pressure. In particular, the present invention provides a method of “solvothermal vapor synthesis” (SVS) for facilitating the crystallization of a phase from a mixture of precursors in the unsaturated vapor phase of a reaction medium containing a predetermined amount of gaseous carbon dioxide. In some embodiments, the reaction medium is water, and the method is referred to as “hydrothermal vapor synthesis” (HVS).

The methods of the present invention allow for convenient and efficient manipulation of pressure and temperature and can be utilized in the synthesis of materials such as scawtite, wollastonite, xonotlite, and quartz.

The following non-exclusive list of materials can be synthesized according to the HVS method of the present invention:
1. MgAl₂O₄
2. Mg₆Al₂CO₃(OH)₁₆*4H₂O
3. CaSiO₃
4. Ca₆SiO₇(OH)₂
5. Ca₇Si₆CO₃O₁₈·2(H₂O)
6. 2Y₃Al₅O₁₂
7. SrZrO₃
8. ZnAl₂O₄
9. CaTiO₃
10. Ba₂Ti₉O₂₀
11. LiMn₂O₄
12. Li₂MnO₃
13. Co₃O₄
14. LiCoO₂
15. Y₂Ti₂O₇
16. Li₂Mn₂O₃
17. LiV₃O₈

Other multi-cation compounds include but are not limited to magnesium silicate, calcium-magnesium silicate, all oxides containing one or more alkaline earth cations combined with any suitable cation, all oxides containing aluminum ions in combination with any suitable ion, and all oxides that contain silicon and any suitable ion.

Throughout this patent document, various publications are referenced. The disclosures of these publications in their entireties are hereby incorporated by reference into this application in order to more fully describe the state of the art to which the disclosed matter pertains. While the following text may reference or exemplify specific elements of a composite or a method of utilizing the composite, it is not intended to limit the scope of the invention to such particular reference or examples. Various modifications may be made by those skilled in the art, in view of practical and economic considerations, such as the temperature and pressure of the reaction conditions and the ratio between the calcium and silicon precursors.

The articles “a” and “an” as used herein refers to “one or more” or “at least one,” unless otherwise indicated. That is, reference to any element or component of the present invention by the indefinite article “a” or “an” does not exclude the possibility that more than one element or component is present.

The term “about” as used herein refers to the referenced numeric indication plus or minus 10% of that referenced numeric indication.

The terms “vapor” and “gas” are used interchangeably throughout this document. When referring to the solvothermal or hydrothermal vapor atmosphere, this means the vapor is unsaturated gas.

The term reaction catalyst as used herein refers to a material (liquid, solid, gas, ionic, or supercritical) that is added to the raw material mixture prior to or during the reaction. The catalyst typically does not change the thermodynamics of the reaction system, but does typically change the reaction rate (faster or slower).

The term “metal silicate hydrate” refers to a metal silicate compound in hydrate form. Alternatively, the formula of the metal silicate hydrate contains one or more OH groups. Likewise the term “metal carbonate hydrate” is a metal carbonate compound in hydrate form or the formula of the compound contains one or more OH groups.

The term “precursor” as used herein refers to any material leading to the formation of the target product. A precursor may be in the form of a solid, liquid, gas, ionic, or supercritical species. Examples of solid precursors include metals (Aluminum, Iron, Cobalt, Copper, Zinc, Magnesium, Titanium etc.), ceramics (carbonates, hydroxides, oxides, carbides, bromides, borides, nitrides, fluorides, iodides, arsenides, selenides, phosphides, sulfides, tellurides, hydrides, etc.). Additional examples for oxides includes MgO, Al₂O, CaO, and Mn₂O₃. Additional examples for Hydroxides include Mg(OH)₂, Al(OH)₃, AlO(OH), Ba(OH)₂. Additional examples for Carbonates include MgCO₃, CaCO₃, BaCO₃, and Na₂CO₃. The term “metal oxide precursor” includes metal oxide, metal hydroxide, and metal carbonate. Additional examples for Nitrides include Si₃N₄, Mg₃N₂, (AlN)ₓ·(Al₂O₃)₁₋ₓ. Additional examples for Carbides include SiC, B₄C, WC, MgC₂, and CaC₂. A material or precursor may be in a liquid state. Examples include inorganic materials (MgO (l), NaCl (l), H₂O (l), NaCl—KCl (Eutectics), Ga (l), and NH₃ (l), etc.) and organic materials (C₂H₆O₂ (Ethylene Glycol), C₄H₆O₃ (Propylene Carbonate), (Methanol), C₂H₅OH (Ethanol), C₃H₇OH (isopropanol), etc.). A material may be an inorganic gas (e.g. CO₂, H₂O, N₂, Cl₂, F₂, NH₃) or an organic gas (CH₂O (Formaldahyde), CHCl₃ (Chloroform)). An ionic material may be inorganic (containing for example H+, OH−, Ca₂+, Mg₂+, Na+, Cl−, K+, NH₄+) or organic (containing for example CH₃COO− (Acetate), HCOO− (Formate) or CN− (Cyanide)). A supercritical material may also be inorganic (for example CO₂, CH₄, N₂O, NH₃, N₂) or organic (e.g. C₂H₅OH (Ethanol), CH₃OH (Methanol), C₃H₆O (Acetone)).

The term “solvothermal Vapor Synthesis” (SVS) refers to a method for facilitating the crystallization of a phase from a mixture of selected inorganic or organic precursors in a gaseous solvent reaction medium (subcritical). By adjusting the temperature and the partial pressures of the solvent and monitoring any relevant partial pressures of other gasses, phases can be selectively partitioned out. In the case of water being the solvent, the reaction method is labeled “Hydrothermal Vapor Synthesis” (HVS). The role of the gaseous solvent is to enhance the kinetics of a thermodynamically favorable reaction system. In some cases, the gaseous solvent could participate in the thermodynamics of a reaction (e.g. 6CaCO₃+6SiO₂+H₂O═Ca₆S₁₆O₁₇(OH)₂+CO₂ in unsaturated gaseous H₂O (g)). The departure temperature point at which the liquid-phase no longer exists, may be important in optimizing the reactivity of several systems. This temperature can be changed by modifying the solvent with addition of various solute or increasing/reducing vessel liquid fill fraction. The solvent phase is generally in the form of a subcritical unsaturated gaseous phase. SVS should be substantially free from liquid-phase in the reaction zone. In any SVS reaction, the main reaction medium (e.g., water, acetone, ammonia) is in the subcritical gaseous regime. For example, if the solvent is pure H₂O, the pressure cannot exceed 22.06 MPa (3199.308 psi) at temperatures >374° C. (In the case of pure NH₃, the pressure cannot exceed 11.3 MPa (1638.6 psi) at temperatures >132° C. In all cases, the reaction medium is unsaturated gas, meaning no liquid-phase is present in the reaction zone. Examples of solvent in SVS include water, ammonia, ethanol, methanol, acetone, toluene and benzene. Additional gaseous vapors might be introduced (precursor, or catalyst) to enhance the reaction.

The terms “vapor” and “gas” are used interchangeably throughout this document. When referring to the solvothermal or hydrothermal vapor atmosphere, this means the vapor is unsaturated gas.

The term “liquid” refers to a material that is above its melting temperature and pressure, but below its boiling temperature and pressure.

The term “gas” refers to a material that is above its boiling temperature and pressure, but below its supercritical temperature and pressure.

The term “ionic material” refers to a material that has undergone speciation into its elemental components. The ionic material may be complexed by the solvent.

The term “supercritical material” refers to a material that has exceeded its supercritical temperature and pressure.

The term “inorganic material” or “inorganic reaction product” or “product” refers to a material represented by the formula Aₐ B_{b} C_{c} Z_{z} Y_{y} Xₓ (α)_{f}(β)_{g}(γ)ₕ·i(δ)·j(ε)·k(θ), wherein A, B, C are single or multi-elemental cations, Z, Y, X are single or multi-elemental anions, α, β, γ are charged molecules, and δ, ε, θ are neutral molecules. The material can be either crystalline (ordered), amorphous (disordered), or a mixture of both. (A), (B), and (C) can comprise of a single or multi-elemental cation (positively charged alkali, alkali-earth, transition metal, semi-metal, non-metal, halogen, noble gas, lanthanide, or actinide species) with a concentration of [a], [b], and [c] between ppb (parts per billion) and 100%. (Z), (Y), and (X) can comprise a suitable single or multi elemental anion (negatively charged elemental species, e.g., Oxygen, nitrogen, carbon, fluorine, chlorine, etc) with a concentration of[Z], [Y], and [X] between ppb and 100%. (α), (β), and (γ) can comprise a variety of charged molecules and ligand groups (organic or/and inorganic) with concentrations of [f], [g], and [h] between ppb and 100%. These molecules could be positively or negatively charged (e.g. OH⁻, CO₃⁻, NH₄⁺, NR₄⁺). (δ), (ε), and (θ) can comprise of a variety of neutral molecules and ligand groups (e.g., H₂O) with concentrations of [i], [j], and [k] between ppb and 100%. In some embodiments, a, b, c, d, e, f, g, h, i, j, and k are each a value equal to or greater than 0.

The term “standard-state pressure” refers to a system pressure equal to 1 atm.

The term “non standard-state pressure” refers to a system pressure above or below 1 atm.

The term “non-standard state change in Gibb's free energy” refers to a change in Gibb's free energy associated with the formation of a reaction product at a system pressure above or below 1 atm.

The term “stable” in describing a product or compound refers to its energetic state that has a Gibb's free energy of reaction lower than any other favored reaction products.

The term “metastable” in describing a product or compound refers to its energetic state that has a Gibb's free energy of reaction less than zero, but not lower than other thermodynamically favored reaction products.

The term “supercritical” describes material that has exceeded its supercritical temperature and pressure.

The following abbreviations are used: HVS: Hydrothermal Vapor Synthesis; LPH: Liquid-phase hydrothermal; VPH: Vapor-phase hydrothermal; SCW: Supercritical water.

Unlike LPH, VPH, and SCW synthesis, HVS is conducted at any temperature (>100° C.) and pressure where liquid water no longer exists. The pressurized water vapor atmosphere acts as a reaction catalyst for the synthesis of inorganic materials at relatively low temperatures (<500° C.). This means that HVS enhances the kinetics of a thermodynamically favorable reaction between the selected precursors. Specifically, the main equation governing whether a reaction between precursors is thermodynamically favorable is the Gibb's free energy of reaction:

$$Δ {G}_{rxn}^{o} = \sum Δ {G}_{{f}_{products}} - \sum Δ {G}_{{f}_{reactants}}$$

If the ΔG^{o}ᵣₓₙ is negative, positive, or zero, then the reaction will proceed, not proceed, or remain in equilibrium respectively. The “^{o}” refers to standard state conditions: i.e., Total Pressure=1 atm. The pressure increase inside a hydrothermal vessel is dictated by the water liquid-vapor equilibrium curve and also by any volatile substance that could be adding gaseous products to the mix. Accordingly, any gaseous reactant or product can also contribute to the overall thermodynamics of the reaction system via the following non-standard-state relationship:

$$Δ {G}_{total} = Δ {G}_{rxn}^{o} + RT ln ( K )$$

$$K = \frac{[ products ]}{[ reactants ]} = [ \frac{{a}_{p ( s )} {a}_{p ( g )}}{{a}_{r ( s )} {a}_{r ( g )}} ] = \frac{{P}_{p}}{{P}_{r}}$$

where R is the molar gas constant (8.314 J/mol·K), T is the temperature (Kelvin), K is the reaction equilibrium constant, a is the activity component of the reactants and products, and P is the partial pressure (atm) of the present gases (Subscripts p=product, r=reactant, s=solid, g=gas). If the ΔGₜₒₜₐₗ (non standard-state change in Gibb's free energy for a particular reaction) is negative, positive, or zero, then the reaction will proceed, not proceed, or remain in equilibrium respectively. The present disclosure details how to apply the thermodynamics of a system in the solvothermal vapor environment to predict product formation. In particular, one or more of the temperature, unsaturated vapor pressure, and partial pressure of any gases added or produced are selected to reduce the non-standard state change in Gibb's free energy of the reaction system to less than or equal to zero. In some embodiments, the non-standard state change in Gibb's free energy of the reaction system may be reduced to below zero, or below −10, or below −100, or below −1,000 [kJ/mol]. In some embodiments, the non-standard state change in Gibb's free energy may be reduced down to −10,000 [kJ/mol]. The non-standard state change in Gibb's free energy may also be reduced by the addition of a gaseous, liquid, or solid species, or by the production of a gaseous, liquid, or solid species within the reaction system. The non-standard state change in Gibb's free energy may also be reduced by removal of any of these species from the reaction system.

The solvothermal method deviates from the liquid-vapor equilibrium by eliminating the vessel liquid volume fraction. The utilization of unsaturated vapor increases the versatility of this process by introducing another synthesis variable and one additional degree of freedom; where any pressure (P) can be selected at a given temperature by control of the amount of reaction medium added to the vessel. Tuning this variable can optimize reaction kinetics, phase-purity, crystallite size, and morphology.

In the case of water being the reaction medium, the reaction method is labeled “Hydrothermal Vapor Synthesis.” However, methods of the present disclosure may utilize other reaction mediums such as organic or inorganic species, or mixtures thereof. In some embodiments, the reaction medium may be one or more of ammonia, ethanol, methanol, acetone, toluene and benzene. If the reaction medium comprises more than one species, then at least one the species may in an unsaturated vapor state at the temperature and pressure of the reaction conditions. In some embodiments, the other species may be saturated, subcritical, or critical pressures.

The precursors utilized can be crystalline, amorphous, liquid, or aqueous. The precursors may be well-mixed to ensure a high degree of reaction completion. Precursor mixtures can be suspended above or dispersed in the water residing in the reactor prior to the beginning of the reaction. Each material system will dictate the pressure and therefore liquid fill percent necessary for reaction to proceed.

There are several considerations that make the HVS method possible and unique: (1) Adequate understanding of pressure control within a reactor and (2) Thermodynamic understanding of reaction between selected precursors. The process of HVS in general is explained in US patent application NO. 20190010628, the entire disclosure of which is hereby incorporated by reference. The methods of this patent document facilitate the crystallization of a phase from a mixture of selected inorganic or organic precursors in a water vapor-phase reaction medium. By adjusting the temperature and the partial pressures of water and monitoring any relevant partial pressures of other gasses (e.g., CO₂), phases can be selectively partitioned out. The reaction generally proceeds at a temperature above 100° C. with higher than 1 atm pressure and the water is in the vapor phase (unsaturated vapor).

Gaseous or dissolved CO₂ is typically used to create carbonate phases from inorganic oxide and hydroxide materials. For example, exposing CaO, MgO, or CaSiO₃ to gaseous and dissolved CO₂ will create CaCO₃, MgCO₃, and CaCO₃/SiO₂ under certain thermodynamic conditions. In this patent document, CO₂ is no longer used to create a carbonate, but rather to suppress the formation of a hydroxide phase and resultantly enable the formation of an oxide phase. By modifying the pressure of unsaturated water-vapor and CO₂, an anhydrous oxide at a low temperatures can be produced.

It is suggested in US20190010628 that a product yield limitation exists due to CO₂ evolving in a closed-batch system, with the thermodynamics describing that any presence of CO₂ will begin to stabilize the precursors (CaCO₃ and SiO₂) and no longer favor the formation of CaSiO₃. Thus, it would be intuitive to conclude that removing all presence of CO₂ from the system would result in greater product purity. However, it is surprisingly discovered that CO₂ should not always be considered as a precursor (e.g., CaCO₃) stabilizer, and in-fact can be used to induce the formation of an oxide product phase instead of a carbonate one. This is not intuitively realized in the patent literature, where the role of CO₂ in the formation or partitioning of an oxide product phase is completely ignored.

Specifically, this patent document provides that a thermodynamically prescribed quantity of CO₂ can be introduced into the reaction system to selectively crystallize a hydroxide or an oxide phase. In the method disclosed herein, the Gibb's Free Energy of a synthesis reaction is modified via the introduction of gaseous CO₂. For example, a chemical reaction between CaO or Ca(OH)₂ and SiO₂ in an unsaturated water vapor reaction medium as reported in literature will produce xonotlite (Ca₆Si₆O₁₇(OH)₂) if no gaseous CO₂ is introduced into the system. However in the methods of this patent document, if gaseous CO₂ is introduced at a thermodynamically prescribed concentration, then the hydroxide (i.e., Ca₆Si₆O₁₇(OH)₂) phase is energetically suppressed and CaSiO₃ crystallizes.

One aspect of the invention provides a method of synthesizing a metal silicate, or a metal silicate hydrate. The method includes
providing a silicon precursor and a metal oxide precursor in a reactor;
providing in the reactor a reaction medium comprising a vapor phase of unsaturated water, wherein the vapor phase is an equilibrium unsaturated water vapor, wherein the unsaturated water vapor has a partial pressure of greater than 1 atm;
providing carbon dioxide (CO₂) is in gaseous form; and
reacting the silicon precursor and the metal oxide precursor in the reaction medium at a predetermined temperature to form the metal silicate or the metal silicate hydrate.

In some embodiments, the Gibb's free energy at a particular temperature and unsaturated water vapor pressure of the material mixture will favor the metal silicate to form. In other embodiments, the favored phase will be the metal silicate hydrate. In another embodiment, both the metal silicate and the metal silicate hydrate will be favored to form. In yet another embodiment, both the metal silicate and the metal silicate hydrate will form, but one of the phases will be energetically more favorable than the other. In these embodiments, it may be possible to insert a gaseous species into the reaction chamber that will selectively affect the Gibb's free energy of reaction of the material mixture and promote the formation of either a metal silicate, metal silicate hydrate, or a mixture of the two. Table 7 lists some examples of metal silicates, metal silicate hydrates/hydroxides, and metal silicate hydroxide carbonates that are possible to synthesize with this invention.

Various approaches, including procedures based on HVS can be adopted to implement the methods of this patent document. The reactor can be a closed or sealed system such as a batch-style autoclave. This reactor can also be configured as a semi-batch, continuous, or semi-continuous reaction vessel where precursor feeding and product removal is occurring in a continuous or semi-continuous manner. Where a continuous, semi-continuous, or semi-batch reaction vessel is used, unreacted reactants may be removed and recycled back into the reaction vessel, Nonlimiting examples are provided as follows.

In a first example, the method includes liquid water being added to a batch-style autoclave prior to beginning the reaction process. Specifically, water is placed on the bottom of a batch-style autoclave. The selected mixture of precursors is also placed inside the batch reaction vessel. Two embodiments of placing the material inside the autoclave exist: (1) placing the material into a sample holder that prevents the liquid water from touching the material mixture, or (2) placing the material directly into the liquid water, allowing the liquid water to wet, hydrate, and/or hydroxylate the precursor mixture. CO₂ can be introduced into the reactor before or during the reaction. The amount of water used is determined by the volume of the autoclave. For instance, in the case of a 1-L autoclave, the amount of water can be chosen to be ˜30 mL to have an approximate volume fill-percent of 3% in order to achieve an unsaturated water partial (also referred to as super-heated steam) pressure of about 58 atm at 350° C. The autoclave is heated for a suitable period of time to induce the precursor mixture to react to form a product; after which it is depressurized. After depressurization, the reactor is cooled to room-temperature. After cooling, the reaction product is removed from the autoclave.

In a second example of a modified version of HVS, the batch-style reaction vessel is pressurized with water vapor. In this embodiment, the selected material is placed into the autoclave, and the autoclave is sealed. CO₂ can be introduced into the reactor before or during the reaction. The autoclave is preheated, for example, to 350° C. The autoclave is then pressurized to 58 atm with unsaturated water vapor (also referred to as super-heated steam). The unsaturated water vapor can be produced by a steam generator, water boiler, or other preheating systems. The autoclave remains pressurized at for example 350° C. for 12 h; after which it is depressurized. After depressurization, the reactor is cooled to room-temperature. After cooling, the material is removed from the autoclave.

In a third example of a modified version of HVS, the batch-style reaction vessel is converted to a semi-continuous reactor. In this embodiment, the selected material is placed into the semi-continuous reactor. CO₂ can be introduced into the reactor before or during the reaction. The reactor is preheated to, for example, 350° C. The autoclave is then pressurized to 58 atm with unsaturated water vapor (also referred to as super-heated steam). The unsaturated water vapor can be produced by a steam generator, water boiler, or other preheating systems. This reactor is configured in such a way that precursor feeding and product removal is occurring in a semi-continuous manner. The precursor remains in the reaction zone, for example, at 350° C. for 12 h; after which it is removed from the reactor, with fresh precursor taking its place. This cycle continues in a continuous/semi-continuous manner.

In a fourth example of a fully continuous version of HVS. In this embodiment, the selected material is placed into the continuous reactor. This reactor may have multiple zones with liquid water, gaseous water (unsaturated/superheated), saturated water vapor, wet gaseous water, dry gaseous water, and partially wet/dry gaseous water. The reactor may have multiple zones with zero water species at all (dry). The reaction zone is a location inside the reaction chamber where the crystallization reaction occurs. CO₂ can be introduced into the reactor before or during the reaction. The unsaturated water vapor can be produced by a steam generator, water boiler, or other preheating systems. Unsaturated water vapor can also be produced by microwave heating of solid, microwave heating of liquid, microwave heating of gas, microwave heating of plasma, solar heating (e.g., solar thermal), solar-electric, waste-heat, and geothermal. This reactor is configured in such a way that precursor feeding and product removal is occurring in a continuous/semi-continuous manner. The precursor remains in the reaction zone, for example, at a predetermined temperature for a certain period; after which it is removed from the reactor, with fresh precursor taking its place. This cycle continues in a continuous/semi-continuous manner.

The partial pressure of the unsaturated water vapor can be regulated via the initial fill of liquid water in the reactor. The amount of water as a liquid ranges from about 0.1 to about 40 vol %, all subunits and sub-ranges included, of the total volume of the reaction vessel. In non-limiting exemplary embodiments, the water content is about 1%, 2%, 3%, 4%, 5%, 6%, 7%, 8%, 9%, 10%, 12%, 14%, 16%, 18%, 20%, 22%, 24%, 26%, 28%, 30%, 32%, 34%, 36%, 38%, 40% of the total volume of the reaction vessel. For example, in the case of a reaction at 374° C., the water fill percent may be less than 15.6% to achieve an all-gas (steam) reaction medium. All other cases can be numerically computed and experimentally confirmed. The numeric computation involves equating the pressure values obtained by surveying concentration of water in the Vander-Waals or Redlich-Kwong equations with the pressure in the water liquid-vapor equilibrium curve. One or more additional inert organic solvent may be added to further fine tune the total or partial-gas pressure in the vessel.

After a desirable temperature is reached, the water inside the reaction vessel is substantially in the gaseous state. In some embodiments, more than about 98% or 99% of the water in the vessel is in the gaseous state. In some embodiments, the water in the vessel is in gaseous state and no liquid water exists.

The partial pressure of water in the reactor ranges from about 10 psi to 50000 psi or higher, all subunits and sub-ranges included. Non-limiting ranges include from about 10 psi to about 500 psi, from about 500 psi to about 700 psi, from about 700 psi to about 1000 psi, from about 1000 to about 1500 psi, from about 1500 to about 2000 psi, from about 2000 psi to about 2500 psi, from about 2500 psi to about 3000 psi, from about 2500 psi to 5000 psi, from about 2500 psi to 10000 psi, from about 2500 psi to 20000 psi, from about 5000 psi to 20000 psi and from about 2500 psi to 20000 psi. In other exemplary embodiments, the lower limit of the pressure range is about 150, about 200, about 250, about 300, about 350, about 400, about 450, about 500, about 550, about 600, about 650, about 700, about 750, about 800, about 850, about 900, about 950, about 1000, about 1200, about 1400, about 1600, about 1800, about 2000, about 3000, about 4000, about 5000, about 6000, about 8000, about 10000, about 12000, or about 14000 psi. In some embodiments, the upper limit of the pressure range is about 1000, about 1200, about 1400, about 1600, about 1800, about 2000, about 2200, about 2400, about 2600, about 2800, about 3000, about 3200, about 3400, about 4000, about 5000, about 6000, about 8000, about 10000, about 15000, about 20000, about 25000, or about 30000 psi. In some embodiments, the partial pressure of water in the reactor vessel is about 150, 200, 250, 300, 350, 400, 450, 500, 550, 600, 650, 700, 750, 800, 850, 900, 950, 1000, 1200, 1400, 1600, 1800, 2000, 2200, 2400, 2600, 2800, 3000, 3200, 3400, about 4000, about 5000, about 6000, about 8000, about 10000, about 12000, about 14000, about 16000, about 20000, or about 25000 psi.

In some embodiments, the unsaturated water vapor is a pressurized superheated steam, which is a steam having a temperature greater than 100° C. and not in equilibrium with liquid water.

The partial pressure of CO₂ in the reactor vessel needs to be regulated to control the reaction outcome. The regulation of the partial pressure of other gases may be accomplished by the introduction or removal of CO₂ from the reaction vessel through, e.g., outgassing the reaction vessel. In some embodiments, the partial pressure of CO₂ added or produced are independently between 0.0000001 and 10,000 atm, all subranges and subunits included. In some embodiments, the partial pressure of carbon dioxide ranges from about 0.00000001 to about 1000, from about 0.0000001 to about 0.00001, from about 0.000001 to about 0.0001, from about 0.00001 to about 0.001, from about 0.0001 to about 0.01, from about 0.001 to about 0.1, from about 0.01 to about 0.1, from about 0.1 to about 1, from about 0.1 to about 10, from about 1 to about 10, from about 1 to about 20, from about 1 to about 50, from about 1 to about 100 psi, all subranges and subunits included. Non-limiting examples of the partial pressure of CO₂ include about 0.0005, about 0.001, about 0.005, about 0.01, about 0.05, about 0.1, about 0.5, about 1, about 5, about 10, about 15, about 20, about 25, about 30, about 40, about 50, about 80 and about 100 psi. In some embodiments, the amount of CO₂ ranges from about 50 ppm to about 1000 ppm, from about 100 ppm to about 800 ppm, from about 200 ppm to about 800 ppm, from about 400 ppm to about 800 ppm or from about 200 ppm to about 600 ppm in the reactor. In some embodiments, the amount of CO₂ ranges from about 100 ppm to about 10 atm, from about 100 ppm to about 5 atm, from about 100 ppm to about 1 atm, from about 200 ppm to about 10 atm, from about 500 ppm to about 5 atm, or from about 500 ppm to about 1 atm. In some embodiments, the CO₂ is in the supercritical state. In some embodiments, CO₂ is partially in the liquid state. In some embodiments, CO₂ is completely in the gaseous state.

A significant advantage of the present invention over traditional method is the much lower temperature range and net-energy required in the crystallization process. Not only is the process cost-efficient, it is also environmentally friendly in terms of generating less side reaction products. The temperature of the reaction ranges from about 100° C. to 1000° C., from about 150° C. to 1000° C., from about 150° C. to 800° C., from about 200° C. to 800° C., from about 200° C. to 600° C., from about 400° C. to 600° C., from about 600° C. to 800° C., all subunits and sub-ranges included. In some exemplary embodiments, the lower limit of the temperature range is about 200° C., 250° C., 300° C., 350° C., 400° C., 500° C., 600° C., 700° C., 800° C. or higher, and the upper limit of the range is about 350° C., 400° C., 500° C., 600° C., 700° C., 800° C., 900° C., 1000° C., 1200° C., 1400° C., 1600° C., 1800° C., or 2000° C. More non-limiting examples of temperature include about 150° C., 200° C., 250° C., 300° C., 350° C., 400° C., 450° C., 500° C., 550° C., 600° C., 650° C., 700° C., 750° C., 800° C. 850° C., 900° C., 950° C. and 1000° C.

For example, the CaSiO₃ phase selection according to the methods of this patent document, the partial pressure of CO₂ can range from 100 ppm to 10 atm, and the temperature can range from about 150° C. to about 800° C. In further examples For Mg₂SiO₄ phase selection according to the methods disclosed herein, the partial pressure of CO₂ can range from 100 ppm to 1000 atm, and the temperature ranges from about 150° C. to about 800° C.

The reaction temperature, the pressure of the unsaturated vapor pressure, and the pressure of CO₂ are selected to reduce the non-standard state change in Gibb's free energy of the reaction for the formation of the metal silicate or the metal silicate hydrate to less than or equal to zero kJ/mol. As illustrated in the examples, the three factors directly impact the identity of the products. In some embodiments, the temperature, the pressure of the unsaturated vapor pressure, and the pressure of CO₂ are selected so that the synthesis is selective for the metal silicate over the metal silicate hydrate. In some embodiments, the temperature, the pressure of the unsaturated vapor pressure, and the pressure of CO₂ are selected so that the synthesis is selective for the metal silicate hydrate over the metal silicate. In some embodiments, the temperature, the pressure of the unsaturated vapor pressure, and the pressure of CO₂ are selected so that metal silicate is sole or main thermodynamically stable phase in the product. In some embodiments, the temperature, the pressure of the unsaturated vapor pressure, and the pressure of CO₂ are selected so that metal silicate hydrate is sole or main thermodynamically stable phase in the product. In some embodiments, the temperature, the pressure of the unsaturated vapor pressure, and the pressure of CO₂ are selected so that metal silicate is sole or main thermodynamically metastable phase in the product. In some embodiments, the temperature, the pressure of the unsaturated vapor pressure, and the pressure of CO₂ are selected so that metal silicate hydrate is sole or main thermodynamically metastable phase in the product. When a compound is the main thermodynamically stable phase in the product, it is more than 50%, more than 60%, more than 70%, more than 80% or more than 90, or more than 95% by weigh in the product.

Nonlimiting examples of metal silicates in the methods disclosed herein include calcium silicate CaSiO₃, Ca₂SiO₄, Ca3SiO5, Ca3Si2O7, MgSiO3, MgCaSi2O6 and Mg2SiO4. Nonlimiting examples of metal silicate hydrates include Ca6Si6O17(OH)2, Ca5(SiO4)2(OH)2, Foshagite, Serpentine, Chrysotile, Talc, and alike. Nonlimiting examples of metal silicates include one or more of those oxygen containing compounds listed in Table 7. Depending on the specific conditions, these metal silicates can be reaction precursors or reaction products.

Precursors include for example metal oxide, metal carbonate, metal hydroxide, and a silicon source. The silicon source can be derived from SiO₂, or any other silicon source, for example, SiCl₄ or TEOS (Tetraethyl Orthosilicate, Si(OC₂H₅)₄, or orthosilic acid (Si(OH)₄), or any water soluble or non-soluble silicate, for example, NaSiO₃, Na₂Si₂O₅. The Si source can also be any multicomponent silicate, for example alkali silicates, alumino silicates, feldspars. Additional examples of silicon dioxide (amorphous or crystalline) as a precursor include quartz, silica flour, siliceous sand, diatomaceous earth, clays, silica gel, and combination thereof. Meanwhile, the metal oxide precursor such as calcium oxide source include calcium carbonate, calcium oxide, calcium hydroxide, calcium silicate, other single/multi cation species and any combination thereof. In some embodiments, metal oxide precursors are in the formula of Aₐ B_{b} C_{c} Z_{z} Y_{y} Xₓ (α)_{f}(β)_{g} (γ)ₕ·i(δ)·j(ε)·k(θ), the components of which are as defined above. Nonlimiting examples of metal oxide precursors include one or more those oxygen containing compounds listed in Table 7. Further examples of metal oxide precursor include CaO, Ca(OH)₂, CaCO₃, MgO, Mg(OH)₂, MgCO₃, MgCO₃—hydrates thereof and any combination thereof.

In some embodiments, the precursors include SiO₂ and at least one of CaO, Ca(OH)₂, and CaCO₃. In some embodiments, the precursors include Ca(OH)₂ and SiO₂. In some embodiments, the precursors include CaO and SO₂ CaCO₃ and SiO₂.

The ratio between the silicon in the silicon source and the calcium oxide in the calcium oxide source ranges from about 0.5:1 to 10:1, all sub-ratio included. Non-limiting examples include about 0.6:1, 0.8:1, 1:1, 1.2:1, 1.4:1, 1.6:1, 1.8:1:2:1, 2.2:1, 2.4:1, 2.6:1, 2.8:1, 3:1, 4:1, 5:1, 6:1, 7:1, 8:1, and 9:1. The precursors should be thoroughly mixed to create desirable particle contact and avoid reaction limiting particle separation.

The amount of calcium hydroxide or calcium carbonate in the calcium source may be adjusted to modify the composition of the product and the rate of the reaction. In some embodiments, the calcium oxide source comprises more than about 10%, 20%, 30%, 40%, 50%, 60%, 70%, 80%, or 90% of calcium hydroxide or calcium carbonate. In some embodiments, the calcium source comprises mainly calcium hydroxide in order to obtain a pellet configuration. In some embodiments, the calcium source comprises mainly calcium carbonate in order to obtain a powder configuration.

The particle size of the above reaction precursors is preferably less than about 600 mesh to ensure a thorough mixing of the precursors and promote a fast crystallization process. In some embodiments, the particle size of one or more of the precursors including the silicon source and the calcium oxide source is less than about 500, 400, 350, 300, 250, 200, 150, or 100 mesh. In some embodiments, the particle size of one or more of the precursors including the silicon source and the calcium oxide source is less than 1, 2, 3, 4, 5, 6, 7, 8, 9, 10, 15, 20, 25, 30, 35, 40, 45, 50, 55, 60, 65, 70, 75, 80, 85, 90, 95, 100, 200, 300, 400, 500, or 1000 microns. In some embodiments, the particle size of the precursors may be within a range, e.g., between 1 and 5 microns, 8 and 10 microns, 25 and 35 microns, 50 and 100 microns, etc. The techniques used to mix the precursors and obtain a desired particle size are known to those of ordinary skill in the art, and may include, e.g., attrition milling, ball milling, ultrasonic de-agglomeration, etc., or combinations thereof.

An additional material such as an acid, a base or a salt may be added to the above reaction precursors to facilitate the crystallization process. In some embodiments, the reactant mixture consists essentially of a silicon source, a calcium oxide source and a salt. Exemplary salts include potassium chloride, potassium bromide, sodium chloride, and sodium bromide. In some embodiments, the salt is sodium chloride. In some embodiments, basic or acidic additives may be introduced to enhance or modify the reaction. In some embodiments the basic additive is sodium hydroxide. In some embodiments the acidic additive is magnesium chloride. The exact amount of salt depends on the specific salt additive and the product and can be determined by one of ordinary skill in the art without undue experiments.

The composition or mixture of the reactants can be exposed to water steam or dispersed in liquid water. In some embodiments, the exposure is limited to water steam only. In some embodiments, the composition is exposed to the steam after initially being dispersed liquid water.

The silicon source, the calcium oxide source and other additives may be exposed to the desirable pressure and temperature for any period of time depending on the specific composition of the target product. In exemplary embodiments, the reaction condition is maintained for about 10 minutes, 20 minutes, 40 minutes, 1 hour, 2 hours, 3 hours, 4 hours, 6 hours, 8 hours, 10 hours, 12 hours, 14 hours, 16 hours, 18 hours, 20 hours, 30 hours, 35 hours, 40 hours or longer before the product is collected.

Also provided is a compound prepared according to the above described methods. The compounds synthesized through methods disclosed herein are of crucial importance to anyone that has interest in the field of calcium silicate synthesis, carbon dioxide emissions, and manipulation of hydrothermal reactions for the synthesis of inorganic oxide materials. A variety of metal inosilicate minerals or related compounds including scawtite, xonotlite, wollastonite, alite, and belite can be represented by CaₐSi_{b}O_{c}(CO₃)_{d}(OH)ₑ. In some embodiments, a, b, and c are each greater than 0, and d and e are each equal or greater than 0. In some embodiments, the formula is CaₐSi_{b}O_{c}·(H₂O)_{f}, wherein f is a value equal or greater than 0. In some embodiments, the formula is CaₐSi_{b}O_{c}. In some embodiments of the formulas, a+2b=c. In some embodiments, the values of a, b and c are independently selected from 1, 2, 3, 4, 5, 6, 7, 8, 9 and 10. In some embodiments, the values of d, e and f are independently selected from 0, 1, 2, 3, 4, 5, 6, 7, 8, 9 and 10. Non-limiting examples of compounds under the formula include Xonotlite (Ca₆SiO₁₇(OH)₂), Scawtite (Ca₇Si₆O₁₈(CO₂)·2(H₂O)), wollastonite (CaSiO₃), belite (Ca₂SiO₄), and alite (CaSiO₅). Additional examples of compounds that can be prepared with the methods of this patent document are provided in Table 7.

In some embodiments, the product is a powder. In some embodiments, the powder can hydrate to form a cementitious product. In some embodiments, the powder can carbonate to form a cementitious product.

Another aspect of the patent document provides a method of forming a cementitious product. The method includes hydrating or carbonating the metal silicate or metal silicate hydrate prepared according to the method disclosed herein. In some embodiments, the metal silicate or metal silicate hydrate is a powder.

Another aspect of the patent document provides a method of changing the amount of a metal silicate hydrate or a metal carbonate hydrate in a composition. The reaction conditions can be adjusted similarly as in the methods described above. The method includes:
providing in a reactor a reaction medium comprising a vapor phase of unsaturated water, wherein the vapor phase is an equilibrium unsaturated water vapor, wherein the unsaturated water vapor has a partial pressure of greater than 1 atm;
contacting the composition with gaseous carbon dioxide (CO₂) at a predetermined temperature;
wherein the temperature, the pressure of the unsaturated vapor pressure, and the pressure of CO₂ are selected to change the amount of the metal silicate hydrate or the metal carbonate hydrate.

In some embodiments, the temperature, the pressure of the unsaturated vapor pressure, and the pressure of CO₂ are selected to convert the metal silicate hydrate to a metal silicate. In some embodiments, the temperature, the pressure of the unsaturated vapor pressure, and the pressure of CO₂ are selected to convert the metal carbonate hydrate to a metal oxide. In some embodiments, the metal carbonate hydrate is Mg₆Al₂CO₃(OH)₁₆*4(H₂O) and the metal oxide is MgAl₂O₄. Nonlimiting examples of the metal silicate hydrate and metal silicate are provided in Table 7.

CO₂ Source: the gaseous CO₂ can be provided to the reaction zone from the following sources: (1) direct from atmosphere, (2) desorption of adsorbate, (3) thermal, hydrothermal, hydrothermal vapor (unsaturated water vapor), or chemical decomposition of an organic or inorganic compound to form CO₂ gas, (4) Oxidation of hydrocarbons and elemental carbon by water or air to form carbon monoxide and then catalyzed oxidation of CO to form CO₂ (e.g., Platinum on titania or zirconia, and other systems), (5) Direct oxidation of carbon to form carbon dioxide, (δ) decomposition of calcium carbonate, or any other carbonate or CO₂-bearing materials, (7) combustion of fuel, (8) direct CO₂ release from a metal silicate carbonate, (8) The exothermic Boudouard reaction where CO disproportionates into carbon dioxide and elemental carbon, (9) pressurized CO₂ gas, (10) insertion of liquid CO₂, (11) insertion of solid CO₂, (12) any method of gaseous CO₂ sourcing, and (13) any combination of the above. These sources may be used to generate the desired gaseous CO₂ pressure and concentration within the reaction chamber. These sources may also be used to generate the desired gaseous CO₂ pressure and concentration outside of the reaction chamber. This CO₂ would be subsequently injected into the reaction chamber.

### EXAMPLES

### Example 1—Ca₆Si₆O₁₇(OH)₂ Synthesis from CaO and SiO₂

6 grams of SiO₂ precursor was thoroughly mixed with 5.6 g of CaO precursor. The mixing process was completed by dry mixing the two components inside a small ceramic (ZrO₂) jar (SPEX mill) with 2 spherical zirconia balls (3 mm) for 10 min. The amount of each precursor was chosen to achieve a 1:1 molar mass mixture. This precursor mixture was placed into a sample holder that prevents any liquid water from touching the material mixture. The sample holder was placed on the bottom of a batch-style 1-L autoclave that is capable of housing temperatures and pressures up to 500° C. and 5000 psi, respectively. De-ionized liquid water (18 M-ohm) was placed on the bottom of the autoclave outside of the sample holder to ensure that the precursor mixture is not in contact with the liquid water. The amount of water used is determined by the volume of the autoclave. In the case of a 1-L autoclave, the amount of water is chosen to be ˜50 mL to have an approximate volume fill-percent of 5% in order to achieve an unsaturated water partial pressure of about −81 atm at 400° C. The autoclave was heated for 12 h; after which it was depressurized. After depressurization, the reactor was cooled to room-temperature. After cooling, the reaction product was removed from the autoclave.

According to the computed chemical equilibrium, gaseous CO₂ in any concentration can affect the purity and identity of the product phase. Further, any CO₂ partial pressure can alter the chemical reaction's Gibb's free energy and create zones of stability and metastability of particular phases. These zones of stability and metastability can be computed by calculating the equilibrium temperatures of selected reaction products and comparing the Gibb's free energy of the selected reaction product to other thermodynamically favored phases. Stability and metastability zones are thus a function of temperature, CO₂ pressure, and water partial pressure. For instance, under certain conditions, Ca₆Si₆O₁₇(OH)₂ is never the sole thermodynamically stable phase, and CaSiO₃ always accompanies it in stable or metastable form.

In the case of this example, the raw material mixture was >99% pure and had negligible adsorbed CO₂. Therefore, it can be assumed that the CO₂ concentration inside the autoclave at room-temperature was approximately 400 ppm (atmospheric). This concentration does not favor the formation of a carbonate, and instead stabilizes the calcium silicate hydrate. The CaSiO₃ phase is metastable under these conditions.

The powder retrieved was analyzed via x-ray diffraction which revealed that the only new phases formed were Ca₆Si₆O₁₇(OH)₂ (Xonotlite, Eq. 1) and CaSiO₃ (Wollastonite) (Eq. 2). A small amount of Foshagite (Ca₄(Si₃O₉)(OH)₂) was also detected.

6CaO+6SiO₂+H₂O⇄Ca₆Si₆O₁₇(OH)₂ Eq. 1

CaO+SiO₂⇄CaSiO₃ Eq. 2

The extent of reaction (i.e., how much of the precursor was consumed) depended on the mixedness of the initial powder blend. If the mixedness was low, unreacted phases such as CaO, SiO₂, and hydrated CaO (Ca(OH)₂) formed. Additionally, if mixture was not-uniform, precursor excess regions may favor the formation of a non 1:1 molar compound. This can be evidenced by the formation of the Foshagite (Ca₄(Si₃O₉)(OH)₂) phase.

Additionally, this example was based on a thermodynamic model that is based on calcium silicate hydrate (Ca₆Si₆O₁₇(OH)₂) and calcium silicate (CaSiO₃). In other scenarios, there may be different phases that exist. For example, other hydrates and other oxides, that may form as metastable or stable phases. Therefore, this example is just one possible phase configuration that is possible. Many other calcium-silicate based phase assemblages are possible.

### Example 2—CaSiO₃ Synthesis from CaO and SiO₂

6 g of SiO₂ was thoroughly mixed with 5.6 g of CaO. The mixing process was completed by dry mixing the two components inside a small ceramic (ZrO₂) jar (SPEX mill) with 2 spherical zirconia balls (3 mm) for 10 min. The amount of each precursor was chosen to achieve a 1:1 molar mass mixture. This precursor mixture was placed into a sample holder that prevents any liquid water from touching the precursor mixture. The sample holder was placed on the bottom of a batch-style 1-L autoclave that was capable of withstanding temperatures and pressures up to 500° C. and 5000 psi, respectively. De-ionized liquid water (18 M-ohm) was placed on the bottom of the autoclave outside of the sample holder to ensure that the material mixture was not in contact with the liquid water. The amount of water used was determined by the volume of the autoclave. In the case of a 1-L autoclave, the amount of water was chosen to be ˜50 mL to have an approximate volume fill-percent of 5% in order to achieve an unsaturated water partial pressure of about 81 atm at 400° C. The autoclave was assembled and sealed.

To avoid the hydrate phase (Ca₆Si₆O₁₇(OH)₂) identified in example 1, gaseous CO₂ was introduced into the autoclave at a very specific pre-selected partial pressure. At 25° C., the partial pressure of CO₂ introduced was at least ˜0.68 atm. This CO₂ partial pressure increased by heating the autoclave to 400° C. to achieve a partial pressure of ˜1.54 atm (Redlich-Kwong, Equation of state for non-ideal gas). According to computed chemical equilibrium diagram and the computed stability and metastability diagrams, this CO₂ partial pressure created conditions in which CaSiO₃ was the sole thermodynamically stable phase.

Once the CO₂ gas was introduced, the autoclave was heated for 12 h; after which it was depressurized to atmospheric pressure. After depressurization, the reactor was cooled from 400° C. to room-temperature. After cooling, the material was removed from the autoclave. The powder retrieved was analyzed via x-ray diffraction which revealed that the only new phase formed is CaSiO₃ (Wollastonite) (Eq. 3). A small amount of unreacted SiO₂ and newly formed CaC₀₃ (from the reaction between CaO precursor and CO₂ overpressure) was also detected in x-ray diffraction.

CaO+SiO₂⇄CaSiO₃ Eq. 3

The purity of the CaSiO₃ will depend on the degree of mixture homogeneity (mixedness) of the original material mixture. If the mixedness was low, unreacted phases such as CaO, SiO₂, and hydrated CaO (Ca(OH)₂) will have formed. If the mixedness was high, then all of the precursor phases will be consumed and only the product phase will be present.

### Example 3—Phase Selection

The information in Tables 1-5 was derived from the computed diagrams and describes examples of reaction conditions that create a thermodynamic condition in which CaSiO₃ or Ca₆Si₆O₁₇(OH)₂ is the unstable, stable, or metastable phase.

The shift of the metastable region can be observed depending on the reaction condition. For instance, under certain conditions a shift towards the lower temperatures creates a large field in which CaSiO₃ is metastable and Ca₆Si₆O₁₇(OH)₂ is stable.

TABLE 1
Thermodynamically favored phases from the reaction between
CaO, SiO₂, H₂O, and CO₂ at a P_{H2O} of 0.1 atm. CaSiO₃
refers to Wollastonite. Ca₆Si₆O₁₇(OH)₂ refers
to Xonotlite.

| Temp | P_{CO2} | P_{H2O} | | |
|---|---|---|---|---|
| (° C.) | (atm) | (atm) | Stable | Metastable |
| 400 | 0.0004 | 0.1 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaSiO₃ | — |
| 400 | 0.01 | 0.1 | Ca₆Si₆O₁₇(OH)₂ | CaSiO₃ |
| 300 | | | CaSiO₃ | Ca₆Si₆O₁₇(OH)₂ |
| 200 | | | CaSiO₃ | — |
| 150 | | | CaCO₃ and SiO₂ | — |
| 400 | 0.1 | 0.1 | CaSiO₃ | Ca₆Si₆O₁₇(OH)₂ |
| 300 | | | CaSiO₃ | — |
| 200 | | | CaCO₃ and SiO₂ | — |
| 150 | | | CaCO₃ and SiO₂ | — |
| 400 | 1 | 0.1 | CaSiO₃ | — |
| 300 | | | CaSiO₃ | — |
| 200 | | | CaCO₃ and SiO₂ | — |
| 150 | | | CaCO₃ and SiO₂ | — |
| 400 | 10 | 0.1 | CaSiO₃ | — |
| 300 | | | CaCO₃ and SiO₂ | — |
| 200 | | | CaCO₃ and SiO₂ | — |
| 150 | | | CaCO₃ and SiO₂ | — |

TABLE 2
Thermodynamically favored phases from the reaction
between CaO, SiO₂, H₂O, and CO₂ at a P_{H2O} of 1 atm.

| Temp | P_{CO2} | P_{H2O} | | |
|---|---|---|---|---|
| (° C.) | (atm) | (atm) | Stable | Metastable |
| 400 | 0.0004 | 1 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaSiO₃ | — |
| 400 | 0.01 | 1 | Ca₆Si₆O₁₇(OH)₂ | CaSiO₃ |
| 300 | | | CaSiO₃ | Ca₆Si₆O₁₇(OH)₂ |
| 200 | | | CaSiO₃ | — |
| 150 | | | CaCO₃ and SiO₂ | — |
| 400 | 0.1 | 1 | Ca₆Si₆O₁₇(OH)₂ | CaSiO₃ |
| 300 | | | CaSiO₃ | — |
| 200 | | | CaCO₃ and SiO₂ | — |
| 150 | | | CaCO₃ and SiO₂ | — |
| 400 | 1 | 1 | CaSiO₃ | — |
| 300 | | | CaSiO₃ | — |
| 200 | | | CaCO₃ and SiO₂ | — |
| 150 | | | CaCO₃ and SiO₂ | — |
| 400 | 10 | 1 | CaSiO₃ | — |
| 300 | | | CaCO₃ and SiO₂ | — |
| 200 | | | CaCO₃ and SiO₂ | — |
| 150 | | | CaCO₃ and SiO₂ | — |

TABLE 3
Thermodynamically favored phases from the reaction between
CaO, SiO₂, H₂O, and CO₂, at a P_{H2O} of 10 atm.

| Temp | P_{CO2} | P_{H2O} | | |
|---|---|---|---|---|
| (° C.) | (atm) | (atm) | Stable | Metastable |
| 400 | 0.0004 | 10 | Ca₆Si₆O₁₇(OH)₂ | CaSiO₃ |
| 300 | | | Ca₆Si₆O₁₇(OH)₂ | CaSiO₃ |
| 200 | | | CaSiO₃ | Ca₆Si₆O₁₇(OH)₂ |
| 150 | | | CaSiO₃ | — |
| 400 | 0.01 | 10 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaCO₃ and SiO₂ | — |
| 400 | 0.1 | 10 | Ca₆Si₆O₁₇(OH)₂ | CaSiO₃ |
| 300 | | | CaSiO₃ | — |
| 200 | | | CaCO₃ and SiO₂ | — |
| 150 | | | CaCO₃ and SiO₂ | — |
| 400 | 1 | 10 | CaSiO₃ | — |
| 300 | | | CaSiO₃ | — |
| 200 | | | CaCO₃ and SiO₂ | — |
| 150 | | | CaCO₃ and SiO₂ | — |
| 400 | 10 | 10 | CaSiO₃ | — |
| 300 | | | CaCO₃ and SiO₂ | — |
| 200 | | | CaCO₃ and SiO₂ | — |
| 150 | | | CaCO₃ and SiO₂ | — |

TABLE 4
Thermodynamically favored phases from the reaction between
Cao, SiO₂, H₂O, and CO₂ at a P_{H2O} of 100 atm.

| Temp | P_{CO2} | P_{H2O} | | |
|---|---|---|---|---|
| (° C.) | (atm) | (atm) | Stable | Metastable |
| 400 | 0.0004 | 100 | Ca₆Si₆O₁₇(OH)₂ | CaSiO₃ |
| 300 | | | Ca₆Si₆O₁₇(OH)₂ | CaSiO₃ |
| 200 | | | CaSiO₃ | Ca₆Si₆O₁₇(OH)₂ |
| 150 | | | CaSiO₃ | — |
| 400 | 0.01 | 100 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaCO₃ and SiO₂ | — |
| 400 | 0.1 | 100 | Ca₆Si₆O₁₇(OH)₂ | CaSiO₃ |
| 300 | | | CaSiO₃ | — |
| 200 | | | CaCO₃ and SiO₂ | — |
| 150 | | | CaCO₃ and SiO₂ | — |
| 400 | 1 | 100 | CaSiO₃ | — |
| 300 | | | CaSiO₃ | — |
| 200 | | | CaCO₃ and SiO₂ | — |
| 150 | | | CaCO₃ and SiO₂ | — |
| 400 | 10 | 100 | CaSiO₃ | — |
| 300 | | | CaCO₃ and SiO₂ | — |
| 200 | | | CaCO₃ and SiO₂ | — |
| 150 | | | CaCO₃ and SiO₂ | — |

TABLE 5
Thermodynamically favored phases from the reaction between
Cao, SiO₂, H₂O, and CO₂ at a P_{H2O} of 1000 atm.

| Temp | P_{CO2} | P_{H2O} | | |
|---|---|---|---|---|
| (° C.) | (atm) | (atm) | Stable | Metastable |
| 400 | 0.0004 | 1000 | Ca₆Si₆O₁₇(OH)₂ | CaSiO₃ |
| 300 | | | Ca₆Si₆O₁₇(OH)₂ | CaSiO₃ |
| 200 | | | Ca₆Si₆O₁₇(OH)₂ | CaSiO₃ |
| 150 | | | CaSiO₃ | — |
| 400 | 0.01 | 1000 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaCO₃ and SiO₂ | — |
| 400 | 0.1 | 1000 | Ca₆Si₆O₁₇(OH)₂ | CaSiO₃ |
| 300 | | | Ca₆Si₆O₁₇(OH)₂ | CaSiO₃ |
| 200 | | | CaSiO₃ | — |
| 150 | | | CaCO₃ and SiO₂ | — |
| 400 | 1 | 1000 | CaSiO₃ | — |
| 300 | | | CaSiO₃ | — |
| 200 | | | CaCO₃ and SiO₂ | — |
| 150 | | | CaCO₃ and SiO₂ | — |
| 400 | 10 | 1000 | CaSiO₃ | — |
| 300 | | | CaCO₃ and SiO₂ | — |
| 200 | | | CaCO₃ and SiO₂ | — |
| 150 | | | CaCO₃ and SiO₂ | — |

### Example 4—Mixed Reaction Study (Ca₆Si₆O₁₇(OH)₂ and CaSiO₃)

For crystallizing a product from CaCO₃ and SiO₂, equal molar ratios (1:1) of CaCO₃ (calcite, 98%, CAS #471-34-1, Fisher Scientific, Fair Lawn, NJ) and SiO₂ (quartz, Min-u-sil 40, CAS #14808-60-7, U.S. Silica Co., Berkley Springs, WV,) were attrition wet mixed (Szegvari Attritor System, Type: 01 HDDM, Union Process Inc, Akron, OH) for 10 min with spherical zirconia media (6.5 mm, YSZ, Product #4039GM-S065, Inframat Corporation. Manchester, CT). The mixed powder was dried at 90° C. overnight. After drying, 3 g of powder was suspended over a bath of de-ionized (18.2 MΩ, Rios 5/MilliQ water purification system, Billerica, MA) liquid water in a 1-Liter (Actual volume=1.11 L) Hastalloy (C-276 alloy) hydrothermal reaction vessel (HAST C 1807H₀₄, Parr Instruments, Moline, Illinois). The amount of liquid water placed into the autoclave was 2.88 and 3.15 volume fill % in order to maintain a constant P_{H2O} of 58 atm at the set temperature (350 and 390° C., see Table. 6). The vessel was then sealed according to manufacturer specifications (30 ft-lb of torque per bolt). Afterwards, it was placed into a heater (Cart Heater, 340 atm, 500° C., HT/HP 21571, Parr Instruments, Moline, Illinois), heated to the desired temperature (refer to Table. 4), and held isothermally for 12 h. After 12 h, the vessel was automatically de-pressurized using a computer (Matlab-based software, Kopp Acquire v2.1, Rutgers University, Piscataway, NJ) controlled gas-outlet valve. The gas outlet valve consisted of a stepper motor that was mechanically coupled to gas outlet-valve. A microcontroller (Mega 2560, Arduino) established the connection between the computer and the stepper motor. After depressurization, the reactor was cooled to room-temperature. The dry reaction product was then retrieved from the reactor and fully characterized as described below.

TABLE 6
Experimental parameters for the HVS of CaSiO₃

| | Temperature | Pressure | Experimental Fill |
|---|---|---|---|
| Reaction | (° C.) | (atm) | (%) |
| CaCO₃ + SiO₂ | 350 | 58 | 3.15 |
| CaCO₃ + SiO₂ | 390 | 58 | 2.88 |

X-ray diffraction (XRD) patterns were obtained by scanning the reacted powdered samples (Silicon zero background holder) with a Bruker D8 Discover x-ray diffractometer (Cu-Kα radiation, λ=1.514 Å, 40 kV/40 mA, Parallel beam, Vantec 1 Detector, Karlsruhe, Germany) in the 10-80° 2θ range (step size=0.018*, dwell time=0.5-s). The NIST inorganic crystal structure database (NIST ICSD, FIZ Karlsruhe, Germany) was accessed using the Jade v9.1 pattern analysis software (Materials Data Inc., Livermore, CA) to determine the identity of the constituent phases. Microstructural analyses were conducted on gold sputter coated (20 nm Au) powdered samples (Model EMS150T ES, Electron Microscopy Sciences, Hatfield, PA) with the Field Emission Scanning Electron Microscope (FE-SEM, Carl Zeiss Microscopy GmbH, Jena, Germany) at an accelerating voltage of 5 kV (Working distance 8.5 mm). Thermogravimetric analysis (TGA, Q5000IR, TA Instruments, New Castle, DE) was conducted on the reacted samples to quantify reaction progression by decomposing any remaining CaCO₃ in the product mixture. This analysis consisted of heating the samples from room temperature to 1000° C. at a heating rate of 20° C./min in a flowing N₂ atmosphere (50 mL/min). The amount of remaining CaCO₃ directly corresponds to the amount of calcium silicate product formed. The general relationship shown in Eq. 4 relates the reaction yield (α, mol %) with the mass fraction lost during CaCO₃ decomposition (M_{L}).

$$α = ( 1 - ( \frac{{M}_{L}}{1 - {M}_{L}} \times ( \frac{1}{0.379} ) ) ) \times 100 \% \qquad Eq . 4$$

This relationship assumes the only solid-reaction product to be CaSiO₃ (Eq. 5), and as such, the 1/0.379 factor represents the molar mass ratio between CaSiO₃ and CO₂, which is the amount of CO₂ corresponding to a 0 mol % CaSiO₃ yield reaction. This relationship is more complicated if Ca₆Si₆O₁₇(OH)₂ was also formed (Eq. 6) since there is an additional mass-loss at higher temperatures (>700° C.) from the dehydroxylation of Ca₆Si₆O₁₇(OH)₂.

CaCO₃+SiO₂⇄CaSiO₃+CO₂ Eq. 5

CaCO₃+6SiO₂+H₂O⇄Ca₆Si₆O₁₇(OH)₂+6CO₂ Eq. 6

For this system, accounting of both carbonate content and hydroxide content is necessary to adequately confirm total reaction yield and concentration of individual products. First, the amount of Ca₆Si₆O₁₇(OH)₂ was determined by determining the mass-loss associated with dehydroxylation. This mass-loss was then converted to a molar quantity to describe the molar concentration of carbonate that was utilized to form the Ca₆Si₆O₁₇(OH)₂ phase. Second, the carbonate decomposition was determined from the thermogravimetric decomposition of any remaining CaCO₄. This mass-loss was converted to a molar quantity to describe the total amount of CaCO₃ consumed. Comparing the moles consumed with the moles utilized to form Ca₆Si₆O₁₇(OH)₂, the concentration of the remaining CaSiO₃ phase was determined. It is worth noting that high resolution x-ray diffraction, FTIR analysis, Carl-Fisher Titration, and other techniques not mentioned can also be suitable methods to determine phase formation and corresponding concentration.

According to the developed thermodynamic diagrams, a P_{H}_{₂}_{O} of 58 atm should create thermodynamic conditions that stabilize the Ca₆Si₆O₁₇(OH)₂ phase unless a sufficient concentration of gaseous CO₂ is present inside the autoclave. These conditions also energetically stabilize the CaSiO₃ phase, however this phase is metastable. Experimentally, a 12 h reaction between CaCO₃ and SiO₂ at 350° C. produced both β-CaSiO₃ and Ca₆SiO₁₇(OH)₂ crystalline phases. Unreacted CaCO₃ and SiO₂ account for the remainder of the diffraction peaks. SEM image shows the synthesized rod (acicular) morphology of the CaSiO₃ and Ca₆Si₆O₁₇(OH)₂ crystallites for both the (a) 350 and (b) 390° C. reaction.

The amount of formed CaSiO₃ and Ca₆Si₄O₁₇(OH)₂ was determined by analysis of the thermogravimetric decomposition profile of the reaction products, in which unreacted CaCO₃ and formed Ca₆Si₆O₁₇(OH)₂ was decomposed. It was found that 0.06 g (2.3 wt %) and 0.86 g (32.3 wt %) of CaSiO₃ and Ca₆Si₆O₁₇(OH)₂, respectively, formed in the 350° C. reaction. The 350° C. thermodynamic reaction limit, derived (ideal-gas law) from the chemical equilibria was found to be 0.44 g of Ca₆Si₆O₁₇(OH)₂ and 17.53 g of CaSiO₃ in a 1.11-L reaction volume. The anomaly of exceeding the thermodynamically computed phase ratio for Ca₆Si₆O₁₇(OH) formation is believed to be due to temperature gradients that caused the reaction temperature to be higher than 350° C. at various times in various sections of the autoclave. A closer look at the developed phase diagram reveals that this reaction was predominately in the Ca₆Si₆O₇(OH)₂ and CaSiO₃ stability and metastability phase-field, respectively. Thus, due to the lower than expected concentration of the CaSiO₃ phase, it may be concluded that the formation of Ca₆Si₆O₁₇(OH)₂ halted once the evolved P_{CO}_{₂} de-stabilized the Ca₆Si₆O₁₇(OH)₂ phase. Increasing the reaction time should increase the CaSiO₃ yield further. Similarly, the 390° C. reaction produced 0.51 g (21.3 wt %) of CaSiO₃ and 1.12 g (46.8 wt %) of Ca₆Si₆O₁₇(OH)₂. The thermodynamically computed reaction yield limit for this reaction is 1.05 g of Ca₆Si₆O₁₇(OH)₂ and 40.3 g of CaSiO₃ in a 1-L reaction volume. Once again, its believed thermal-gradients were responsible for the anomaly of exceeding the thermodynamic limit for Ca₆SiO(OH) formation. This higher reaction temperature enabled a slightly higher reaction yield of CaSi₆O₁₇(OH)₂ due to thermodynamic equilibria. This temperature also appears to have increased CaSiO₃ formation kinetics, which can be seen from the greater CaSiO₃ concentration. Thus, the crystallization of both CaSiO₃ and Ca₆Si₄O₁₇(OH)₂ at 350 and 390° C. at a P_{H}_{₂}_{O} of 58 atm agrees well with phase assemblages predicted by the computed thermodynamic models, which suggests that thermochemistry is governing the phase formation for this reaction whose rate of formation is controlled by kinetics.

### Example 5—Mg₃Si₂O₅(OH)₄ Synthesis from MgO and SiO₂

2 grams of SiO₂ precursor is thoroughly mixed with 2.02 g of MgO precursor (3:2 molar ratio). The mixing process was completed by dry mixing the two components inside a small ceramic (ZrO₂) jar (SPEX mill) with 2 spherical zirconia balls (3 mm) for 10 min. The amount of each precursor was chosen to achieve a 3:2 molar mixture. This precursor mixture was placed into a sample holder than prevents any liquid water from touching the material mixture. The sample holder was placed on the bottom of a batch-style 1-L autoclave that is capable of housing temperatures and pressures up to 500° C. and 5000 psi, respectively. De-ionized liquid water (18 M-ohm) was placed on the bottom of the autoclave outside of the sample holder to ensure that the precursor mixture is not in contact with the liquid water. The amount of water used is determined by the volume of the autoclave. In the case of a 1-L autoclave, the amount of water is chosen to be ˜3.5 mL to have an approximate volume fill-percent of 0.35% in order to achieve an unsaturated water partial pressure of about 10 atm at 400° C. The autoclave is heated for 12 h; after which it is depressurized. After depressurization, the reactor is cooled to room-temperature. After cooling, the reaction product is removed from the autoclave.

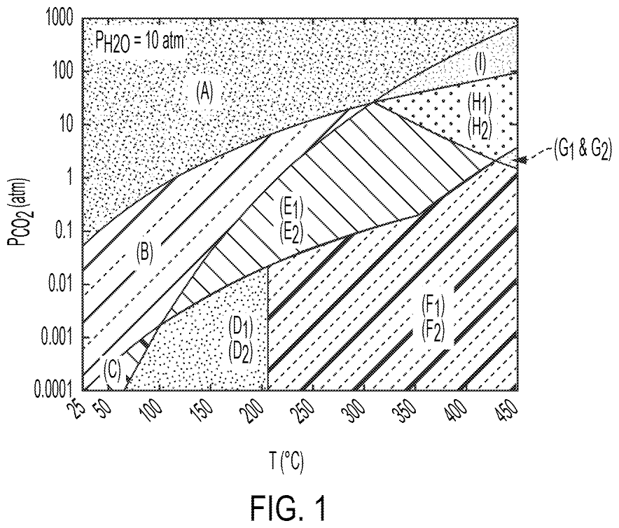

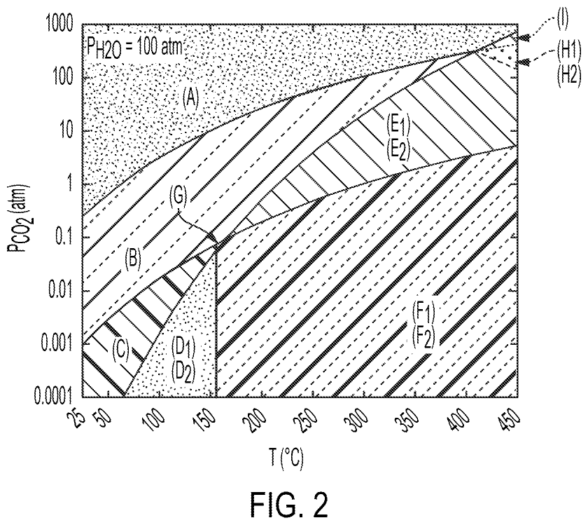

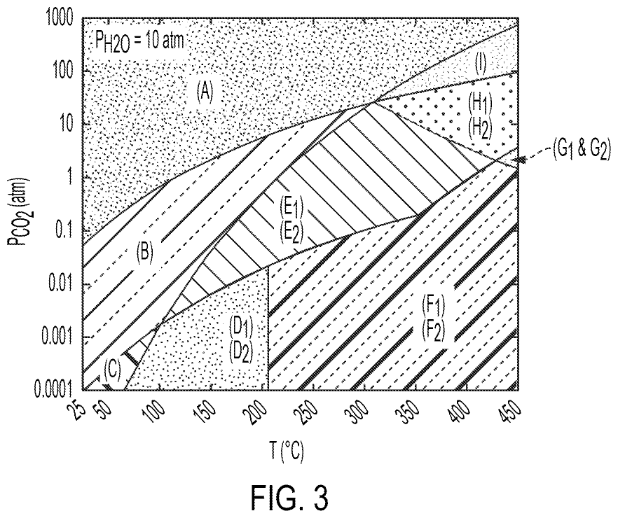

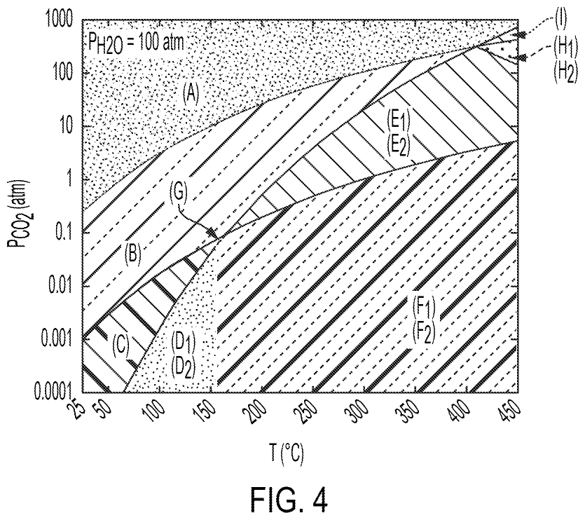

According to the computed chemical equilibrium diagrams, gaseous CO₂ in any concentration can affect the purity and identity of the product phase. Further, any CO₂ partial pressure can alter the chemical reaction's Gibb's free energy and create zones of stability and metastability of particular phases. These zones of stability and metastability can be computed by calculating the equilibrium temperatures of selected reaction products and comparing the Gibb's free energy of the selected reaction product to other thermodynamically favored phases. For this example, stability and metastability zones of Forsterite (Mg₂SiO₄) and Chrysotile (Mg₃Si₂O₅(OH)₄) have been shown as a function of temperature, CO₂ pressure, and water partial pressure. These figures only describe the thermodynamic conditions for phase formation, and do not include additional phases that may form as a result of mixture inhomogeneity. These figures also specifically look at the Mg₂SiO₄ and Mg₄Si₂O₅(OH)₄ phases. There are additional Mg—Si oxide, hydroxide, and carbonate phases that may exist in these conditions. Furthermore, thermodynamic illustrations in FIGS. 1-4 provide additional insight into possible phase formations when starting with different precursor ratios. FIGS. 1 and 2 reflect a Mg:Si molar ratio of 2:1. FIGS. 3 and 4 reflect a Mg:Si molar ratio of 3:2.

In the case of this example, FIG. 3 (zone F₁ and F₂) best describes the thermodynamic equilibria. The raw material mixture was >99% pure and had no adsorbed CO₂. Therefore, it can be assumed that the CO₂ concentration inside the autoclave at room-temperature was approximately 400 ppm (atmospheric). This concentration does not favor the formation of a carbonate, and instead stabilizes the magnesium silicate hydrate (i.e, Mg₃Si₂O₅(OH)₄, while Mg₂SiO₄ is the metastable phase. For every mole of Mg₂SiO₄ phase formed, an equal amount of MgO and SiO₂ is unreacted.

The powder retrieved after the reaction was analyzed via x-ray diffraction which revealed that the formed phases were Mg₃Si₂O₅(OH)₄ (Chrysotile) (Eq. 7) and Mg₂SiO₄ (Forsterite)(Eq. 8).

3MgO+2SiO₂₊₂H₂O⇄Mg₃Si₂O₅(OH)₄ Eq. 7

3MgO+2SiO₂⇄Mg₂SiO₄+MgO+SiO₂ Eq. 8

The purity of the Mg₃Si₂O₅(OH)₄ depended on the mixedness of the initial powder blend. If the mixedness was low, unreacted phases such as MgO, SiO₂, and hydrated MgO (Mg(OH)₂) formed. It is important to note that other phases may exist as kinetic intermediary ones and co-exist for a period of time with the desired products. Additionally, other thermodynamically favorable phases may form/exist during the autoclave heating and pressurization stages, during which the exact thermodynamic conditions have not yet been set. Obtaining phase pure Mg₃Si₂O₅(OH)₄ is possible by operating in thermodynamic zone described in zone B (FIG. 3).

Additionally, this example is based on a thermodynamic model that is based on magnesium silicate hydrate (Mg₃Si₂O₅(OH)₄) and magnesium silicate (Mg₂SiO₃). In other scenarios, there may be different phases that exist. For example, other hydrates and other oxides, that may form as metastable or stable phases. Therefore, this example is just one possible phase configuration that is possible. Many other magnesium-silicate based phase assemblages are possible. Finally, it is also worth noting that the partial pressure of the unsaturated water vapor will also affect the phase equilibria. FIG. 4 is included to illustrate this effect (P_{H2O} of 100 atm).

### Example 6—Mg₂SiO₄ Synthesis from MgO and SiO₂

3 grams of SiO₂ precursor was thoroughly mixed with 4.03 g of MgO precursor (2:1) molar ratio). The mixing process was completed by dry mixing the two components inside a small ceramic (ZrO₂) jar (SPEX mill) with 2 spherical zirconia balls (3 mm) for 10 min. The amount of each precursor was chosen to achieve a 1:1 molar mass mixture. This precursor mixture was placed into a sample holder than prevents any liquid water from touching the material mixture. The sample holder was placed on the bottom of a batch-style 1-L autoclave that is capable of housing temperatures and pressures up to 500° C. and 5000 psi, respectively. De-ionized liquid water (18 M-ohm) was placed on the bottom of the autoclave outside of the sample holder to ensure that the precursor mixture is not in contact with the liquid water. The amount of water used was determined by the volume of the autoclave. In the case of a 1-L autoclave, the amount of water was chosen to be ˜3.5 mL to have an approximate volume fill-percent of 0.35% in order to achieve an unsaturated water partial pressure of about 10 atm at 400° C. The autoclave was heated for 12 h; after which it is depressurized. After depressurization, the reactor was cooled to room-temperature. After cooling, the reaction product was removed from the autoclave.

According to the computed chemical equilibrium diagram, gaseous CO₂ in any concentration can affect the purity and identity of the product phase. Further, any CO₂ partial pressure can alter the chemical reaction's Gibb's free energy and create zones of stability and metastability of particular phases. These zones of stability and metastability can be computed by calculating the equilibrium temperatures of selected reaction products and comparing the Gibb's free energy of the selected reaction product to other thermodynamically favored phases. For this example, FIG. 1 shows stability and metastability zones of Forsterite (Mg₂SiO₄) and Chrysotile (Mg₃Si₂O₅(OR)₄) as a function of temperature, CO₂ pressure, and water partial pressure.

To avoid the hydrate phase Mg₃Si₂O₅(OH)₄ identified in example 5, gaseous CO₂ was introduced into the autoclave at a very specific pre-selected partial pressure. At 25° C., the partial pressure of CO₂ introduced was ˜35 atm. This CO₂ partial pressure increased by heating the autoclave to ˜96 atm (Redlich-Kwong, Equation of state for non-ideal gas) at 400° C. According to the computed stability and metastability diagrams shown in FIG. 1, this CO₂ partial pressure created conditions in which Mg₂SiO₄ was the sole thermodynamically stable phase (zone 1). If a combination of phases was desired, regions H1, H2, G1, G2, E1, E2, D1, D2, F1, and F2 would yield both Mg₂SiO₄ and Mg₃Si₂O₅(OH)₄ in stable and metastable configurations.

Once the CO₂ gas was introduced, the autoclave was heated for 12 h; after which it was depressurized to atmospheric pressure. After depressurization, the reactor was cooled from 400° C. to room-temperature. After cooling, the material was removed from the autoclave. The powder retrieved was analyzed via x-ray diffraction which revealed that the only new phase formed is Mg₂SiO₄ (Forsterite) (Eq. 9).

2MgO+SiO₂⇄Mg₂SiO₄ Eq. 9

The purity of the Mg₂SiO₄ will depend on the mixedness of the original material mixture. If the mixedness was low, unreacted phases such as MgO, SiO₂, and hydrated MgO (Mg(OH)₂) will have formed. If the mixedness was high, then all of the precursor phases will be consumed and only the product phase will be present. Finally, it is also worth noting that the partial pressure of the unsaturated water vapor will also affect the phase equilibria. FIG. 2 is included to illustrate this effect (P_{H2O} of 100 atm).

### Example 7—Asbestos Remediation

Examples 5 and 6 detail how unsaturated water vapor conditions can be used, in conjunction with additional gaseous species, to promote a chemical reaction. It is worthy to note, that the operator can select the unsaturated water vapor conditions and additional gaseous species partial pressures to promote or prevent certain phases. For example, it is possible to convert Chrysolite (asbestos) into non-hazardous form, for example, forsterite or magnesium carbonate by simply adjusting the CO₂ partial pressure, while at unsaturated water vapor conditions. Thus, to convert Chrysolite to Forsterite, the operator can adjust to P_{CO2} in accordance with the phase equilibria shown in FIG. 3. For example, the operator simply needs to raise the CO₂ partial pressure (e.g., raise P_{CO2} to a value between 61.9 and 273.2 atm)., while maintaining the following unsaturated water vapor conditions (pressurized superheated steam): 400° C. and P_{H2O}=10 atm. Further, to convert Chrysolite to Magnesium Carbonate, the operator simply needs to raise the CO₂ partial pressure (e.g., raise P_{CO2} to 5.8 atm), while maintaining the following unsaturated water vapor conditions (pressurized superheated steam): 200° C. and P_{H2O}=10 atm. One of ordinary skill would expect that P_{CO2} carbonates, however, thermodynamics says that you can convert hydroxide to oxide, or vice-versa.

### Example 8—Universal Application

Examples 1-7 highlight the utility of the invention but do not encompass the breadth of the potential material phases in other material systems that can be achieved through a similar route. The introduction of a gaseous species can change the free energy of the reaction system and resultantly promote the crystallization of a phase that would be intuitively expected. For example, gaseous CO₂ can be used to promote the formation of anhydrous MgAl₂O₄ instead of the hydrate carbonate phase, hydrotalcite (MgaAl₂CO₃(OH)₁₆*4(H₂O)). It can also be used to promote the formation of anhydrous Mg₂SiO₄, or promote the formation of any hydrated Mg—Si—O phase. One of ordinary skill would expect that an external pressure of CO₂ would create a carbonate product, however, thermodynamics says that you can convert hydroxide to oxide, or vice-versa.

The purity of the product phase in the examples above also depend on the mixedness of the initial precursors. If the mixedness was low, unreacted precursor phases such as MgO, SiO₂, and hydrated MgO (Mg(OH)₂) will have to be unchanged, or hydrated, or carbonated. If the mixedness was high, then all of the precursor phases will be consumed and only the product phase will be present. Furthermore, the degree of mixedness may modify the stoichiometric proportions of the precursor mix. For example, the intention may be to create a 1:1 molar mixture of CaO and SiO₂, however, a poorly mixed particle system may have regions of CaO or SiO₂ excess. As a result, these excess regions will behave as localized systems whose composition differs and thus forms phase products consistent with those predicted by thermodynamic calculations of a system having the same composition. The size of these localized regions that possess deviations in compositions will vary based on precursor particle size and diffusion path lengths. It is possible that a mixture of ˜0.5 μm particles could have a localized region of ˜10 μm. It is also possible that a mixture of 5.0 μm particles could have a localized of ˜100 μm. For example, the intent may be to synthesize CaSiO₃, but the precursor mixture produces non-uniform concentration zones with a CaO:SiO₂ molar ratio of 2:1, resulting in the formation of Ca₂SiO₄ due to a poorly mixed and distributed precursor particles. Another example is the formation of Ca₆Si₆O₁₇(OH)₂: the intent may be to synthesize Ca₆Si₆O₁₇(OH)₂, but the precursor mixture produces non-uniform concentration zones with a CaO:SiO₂ molar ratio of 4:3, resulting in the formation of Ca₄(Si₃O₉)(OH)₂ due to a poorly mixed and distributed precursor particles. In all examples and practices of this patent document, the mixture homogeneity can directly impact the final product phase and purity.

Several of the examples above describe the formation of CaSiO₃ and Ca₆Si₆O₁₇(OH)₂ from a precursor mixture of CaO and SiO₂. These examples are applicable to Ca(OH)₂ and CaCO₃ calcium sources as well. Additional examples are included that describe the formation of Mg₂SiO₄ and (Mg₃Si₂O₅(OH)₄) from a mixture of MgO and SiO₂. These examples are applicable to Mg(OH)₂ and MgCO₃ magnesium sources as well. It is worth noting that the examples are a non-exclusive list of possible phases that be produced with this invention. In-fact, this invention is applicable to all metal-silicate phases. Furthermore, the examples listed focus on the production of an oxide or a hydroxide silicate phase. It is worth noting that numerous oxide and hydroxide phases (e.g., xonotlite & foshagite) can co-exist at the prescribed thermodynamic conditions. Furthermore, a slight partial pressure of CO₂ may disable one hydroxide phase in favor of the other. The same may exist for oxide silicate phases (e.g., CaSiO₃ & Ca₂SiO₄). Table 7 provides a non-exclusive list of Calcium Silicate and Calcium Silicate Hydrates that may be formed using the invention described in this application. Additional examples of Calcium Silicates are provided in Table 8. Furthermore, it is worth noting that each described example is utilizing the first HVS configuration. In this configuration, a batch style autoclave is loaded with all needed ingredients (precursors, water, gases (CO₂)) and heated to desired temperature. Upon heating the reactor to the desired temperature, the water vapor pressure increases autogenously to get to the desired temperature. During this time, it may be possible to form stable thermodynamic phases that inhibit or contaminate a particular reaction to proceed. While these phases be thermodynamically unstable/unfavorable at the set reaction conditions, the pathway to obtaining those conditions must also be considered.

TABLE 7
Calcium Silicate and Calcium Silicate Hydrates

| Name | Formula |
|---|---|
| (a). Wollastonite group | |
| Foshagite | Ca₄(Si₃O₉)(OH)₂ |
| Hillebrandite | Ca₂(SiO₃)(OH)₂ |
| Nekoite | Ca₃Si₆O₁₅•7H₂O |
| Okenite | Ca₃Si₆O₁₅•6H₂O |
| Pectolite | NaCa₂Si₃O₈ |
| Xonotlite | Ca₆Si₆O₁₇(OH)₂ |
| (b). Tobermorite group | |
| Clinotobermorite c | Ca₅Si₆O₁₇•5H₂O |
| Clinotobermorite d | Ca₅Si₆O₁₇•5H₂O |
| ‘Clinotobermorite | Ca₅Si₆O₁₆(OH)₂ |
| 9 Å’ c | |
| ‘Clinotobermorite | Ca₅Si₆O₁₆(OH)₂ |
| 9 Å’ d | |
| Oyelite | Ca₁₀Si₅B₂O₂₉•12.5H₂O |
| 9 Å tobermorite | Ca₅Si₆O₁₆(OH)₂ |
| (riversideite) c | |
| 9 Å tobermorite | Ca₅Si₆O₁₆(OH)₂ |
| (riversideite) d | |
| Anomalous 11 Å | Ca₄Si₆O₁₅(OH)₂•5H₂O |
| tobermorite c | |
| Anomalous 11 Å | Ca₄Si₆O₁₅(OH)₂•5H₂O |
| tobermorite d | |
| Normal 11 Å | Ca_{4.5}Si₆O₁₅(OH)•5H₂O |
| tobermorite d | |
| 14 Å tobermorite | Ca₅Si₆O₁₆(OH)₂•7H₂O |
| (plombierite) c | |
| 14 Å tobermorite | Ca₅Si₆O₁₆(OH)₂•7H₂O |
| (plombierite) d | |
| (c). Jennite group | |
| Jennite | Ca₉Si₆O₁₈(OH)₆•8H₂O |
| Metajennite | Ca₉Si₆O₁₈(OH)₆•4H₂O |
| (d). Gyrolite Group | |
| Fedorite | (Na,K)₂₋₃(Ca₄Na₃)Si₁₆O₃₈(OH,F)₂•3.5H₂O |
| Gyrolite | NaCa₁₆Si₂₃AlO₆₀(OH)₈•14H₂O |
| K-phase | Ca₇Si₁₋₅O₃₈(OH)₂ |
| Reyerite | (Na,K)₂Ca₁₄(Si,Al)₂₄O₅₈(OH)₈•6H₂O |
| Truscottite | (Ca,Mn)₁₄Si₂₄O₅₈(OH)₈•2H₂O |
| Z-phase | Ca₉Si₁₆O₄₀(OH)₂•14H₂O |
| (e). y-C2S group | |
| Calcium chondrodite g | Ca₅[SiO₄]₂(OH)₂ |
| Kilchoanite | Ca₆(SiO₄)(Si₃O₁₀) |
| (f). Other calcium | |
| silicate phases | |
| Afwillite | Ca₃(SiO₃OH)₂•2H₂O |
| a-C₂SH | Ca₂(HSiO₄)(OH) |
| Cuspidine h | Ca₄(F_{1.5}(OH)_{0.5})Si₂O₇ |
| Dellaite | Ca₆(Si₂O₇)SiO₄(OH)₂ |
| Jaffeite | Ca₆[Si₂O₇](OH)₆ |
| Killalaite | Ca_{6.4}(H_{0.6}Si₂O₇)₂(OH)₂ |
| Poldervaartite i | Ca(Ca_{0.67}Mn_{0.33})(HSiO₄)(OH) |
| Rosenhahnite | Ca₃Si₃O₈(OH)₂ |
| Suolunite | CaSiO_{2.5}(OH)•0.5H₂O |
| Tilleyite | Ca₅Si₂O₇(CO₃)₂ |

(g). Other high temperature cement phases

| | |
|---|---|
| Bicchulite | Ca₂(Al₂SiO₆)(OH)₂ |
| Fukalite | Ca₄[Si₂O₆][CO₃](OH)₂ |
| Katoite Hydrogamet 1 | Ca_{1.46}AlSi_{0.55}O₆H_{3.78} |
| Rustumite | Ca₁₀(Si₂O₇)₂(SiO₄)(OH)₂Cl₂ |
| Scawtite | Ca₇(Si₃O₉)₂CO₃•2H₂O |
| Stratlingite | Ca₂Al₂SiO₇•8H₂O |
| | Ca₂Al(AlSi)_{2.22}O₂(OH)₁₂•2.25H₂O |

TABLE 8
Calcium Silicates
(a). Nesosilicate Subclass (single tetrahedrons)

| | |
|---|---|
| Forsterite | Mg₂(SiO₄) |
| Andradite | Ca₃(Fe³⁺)₂(SiO₄)₃ |
| Grossular | Ca₃Al₂(SiO₄)₃ |
| Pyrope | Mg₃Al₂Si₃O₁₂ |
| Olivine | (Mg,Fe²⁺)₂(SiO₄) |
| Sphene/Titanite | CaTiSiO₅ |
| Larnite | Ca₂SiO₄ |
| Hatrurite (alite) | Ca₃SiO₅ |

(b). Sorosilicate Sublcass (double tetrahedrons)

| | |
|---|---|
| Danburite | CaB₂(SiO₄)₂ |

(c). Inosilicate Subclass (sinf!le and double chains)

| | |
|---|---|
| Augite | (Ca,Na)(Mg,Fe,Al,Ti)(Si,Al)₂O₆ |
| Diopside | MgCaSi₂O₆ |
| Enstatite | MgSiO₃, Mg₂Si₂O₆ |
| Hedenbergite | CaFeSi₂O₆ |
| Hypersthene | (Mg,Fe)SiO₃ |
| Rhodonite | (Mn²⁺,Fe²⁺,Mg,Ca)SiO₃ |
| Wollastonite 1A | CaSiO₃ |

(d). Cyclosilicate Subclass (rings)

| | |
|---|---|
| Cordierite | (Mg,Fe)₂Al₄Si₅O₁₈ |
| Osumilite-(Mg) | (K,Na)(Mg)₂(Al,Fe)₃(Si,Al)₁₂O₃₀ |
| Osumilite-(Fe) | (K,Na)(Fe)₂(Al,Fe)₃(Si,Al)₁₂O₃₀ |
| Pseudo Wollastonite | Ca₃Si₃O₉ |

(e). Tectosilicate Subclass (frameworks)

| | |
|---|---|
| Andesine | (Ca,Na)(Al,Si)₄O₈ |
| Anorthite | CaAl₂Si₂O₈ |
| Bytownite | (Ca,Na)[Al(Al,Si)Si₂O₈] |
| Labradorite | ((Ca,Na)(Al,Si)₄O₈) |
| Oligoclase | (Ca,Na)(Al,Si)₄O₈ |

### Example 9

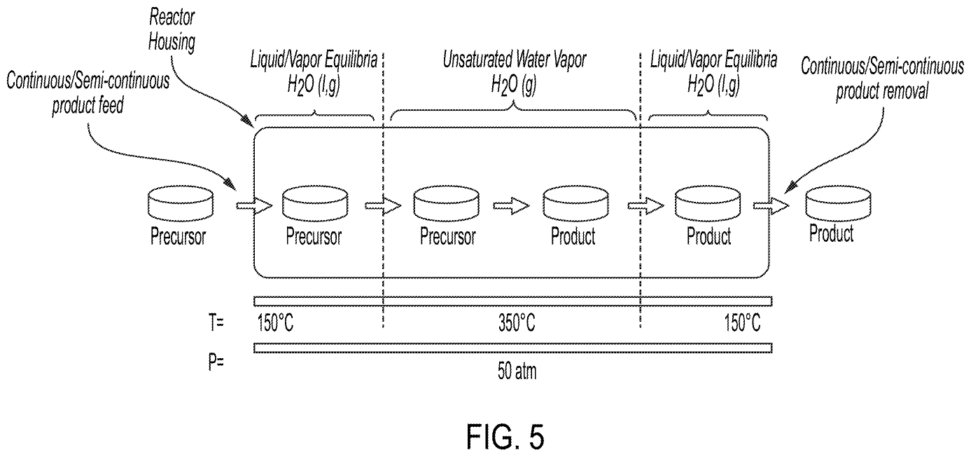

This example illustrates a temperature-gradient-based continuous reactor as shown in FIG. 5. The reaction zone is a location inside the reaction chamber where the crystallization reaction occurs. This zone is heated to 350° C. and has unsaturated gaseous water (pressurized superheated steam). The pressure is determined by the needed parameters and can range from 1-218 atm depending on the chemical parameters. The unsaturated water vapor can be produced by a steam generator, water boiler, or other preheating systems. Unsaturated water vapor can also be produced by microwave heating of solid, microwave heating of liquid, microwave heating of gas, microwave heating of plasma, solar heating (e.g., solar thermal), solar-electric, waste-heat, and geothermal. This reactor is configured in such a way that precursor feeding and product removal is occurring in a continuous/semi-continuous manner. The precursor remains in the reaction zone (350° C.) for 12 h; after which it is removed from the reactor, with fresh precursor taking its place. This cycle continues in a continuous/semi-continuous manner.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A method of synthesizing a metal silicate, or a metal silicate hydrate, or a metal silicate hydrate carbonate comprising:
providing a silicon precursor and a metal oxide precursor in a reactor;
providing in the reactor a reaction medium comprising a vapor phase of unsaturated water, wherein the vapor phase is an equilibrium unsaturated water vapor, wherein the unsaturated water vapor has a partial pressure of greater than 1 atm;
providing carbon dioxide (CO₂) is in gaseous form; and
reacting the silicon precursor and the metal oxide precursor in the reaction medium at a predetermined temperature to form the metal silicate or the metal silicate hydrate;
wherein the temperature, the pressure of the unsaturated vapor pressure, and the pressure of CO₂ are selected to reduce the non-standard state change in Gibb's free energy of the reaction for the formation of the metal silicate or the metal silicate hydrate to less than or equal to zero kJ/mol.

2. The method of claim 1, wherein the temperature, the pressure of the unsaturated vapor pressure, and the pressure of CO₂ are selected so that the synthesis is selective for the metal silicate over the metal silicate hydrate.

3. The method of claim 1, wherein the temperature, the pressure of the unsaturated vapor pressure, and the pressure of CO₂ are selected so that the synthesis is selective for the metal silicate hydrate over the metal silicate.

4. The method of claim 1, wherein the temperature is higher than 100° C.

5. The method of claim 1, wherein the temperature is higher than 400° C.

6. The method of claim 1, wherein the CO₂ ranges from about 100 ppm to about 10 atm in the reactor, and the temperature ranges from about 150° C. to about 800° C.

7. The method of claim 1, wherein the partial pressure of CO₂ is higher than 0.01 atm.

8. The method of claim 1, wherein the partial pressure of CO₂ is selected so that the metal silicate is thermodynamically most stable phase.

9. The method of claim 1, wherein the partial pressure of CO₂ ranges from 400 ppm to 800 ppm.

10. The method of claim 1, wherein the metal silicate is CaSiO₃, Ca₂SiO₄, Ca₃SiO₅, Ca₃Si₂O₇, MgSiO₃, MgCaSi₂O₆ or Mg₂SiO₄.

11. The method of claim 1, wherein the metal silicate hydrate is Ca₆Si₆O₁₇(OH)₂, Ca₃(SiO₄)₂(OH)₂, Ca₄Si₃O₉(OH)₂, Mg₃Si₂O₅(OH)₄ (Serpentine or Chrysotile), or Mg₃Si₄O₁₀(OH)₂.

12. The method of claim 1, wherein the metal oxide precursor is selected from the group consisting of metal oxide, metal hydroxide, metal carbonate, and any combination thereof.

13. The method of claim 1, wherein the metal oxide precursor comprises a member selected from the group consisting of CaO, Ca(OH)₂, CaCO₃, MgO, Mg(OH)₂, MgCO₃, MgCO₃, an oxygen-containing compound of Table 7, hydrate thereof, and any combination thereof.

14. The method of claim 1, wherein the silicon precursor comprises SiO₂.

15. The method of claim 1, wherein the metal oxide precursor comprises CaCO₃ and the silicon precursor comprises SiO₂.

16. The method of claim 1, wherein CO₂ is introduced into the reactor after the silicon precursor and the metal oxide precursor begin to react with each other.

17. The method of claim 1, wherein the unsaturated water vapor is produced by filling less than 5% volume of the rector with liquid water and then heat it to a predetermined temperature.

18. The method of claim 1, wherein the reactor is a closed system.

19. The method of claim 1, wherein the reactor is an open system.

20. The method of claim 1, wherein the metal silicate or metal silicate hydrate is a powder, which is capable for hydrating or carbonating to form a cementitious product.

21. A method of changing the amount of a metal silicate, metal silicate hydrate or a metal silicate carbonate hydrate in a composition, comprising
providing in a reactor a reaction medium comprising a vapor phase of unsaturated water, wherein the vapor phase is an equilibrium unsaturated water vapor, wherein the unsaturated water vapor has a partial pressure of greater than 1 atm;
contacting the composition with gaseous carbon dioxide (CO₂) at a predetermined temperature;
wherein the temperature, the pressure of the unsaturated vapor pressure, and the pressure of CO₂ are selected to change the amount of the metal silicate hydrate or the metal carbonate hydrate.

22. (canceled)

23. (canceled)

24. (canceled)
